(19) United States
(12) Patent Application Publication
(10) Pub. No.: US 2025/0310307 A1
(43) Pub. Date: Oct. 2, 2025

(54) DIGITAL AGENCY CAPSULE ARCHITECTURE

(71) Applicant: Synovient, Inc., Scottsdale, AZ (US)

(72) Inventors: Katalin K. BARTFAI-WALCOTT, El Dorado Hills, CA (US); Donald E. LAKE, III, Denver, CO (US); John S. WALCOTT, El Dorado Hills, CA (US); Matthew ROYER, Hillsboro, OR (US); Richard FOOTE, Portland, OR (US); Vasuki CHILUKURI, Portland, OR (US)

(21) Appl. No.: 19/097,401

(22) Filed: Apr. 1, 2025

Related U.S. Application Data
(60) Provisional application No. 63/573,346, filed on Apr. 2, 2024.
(60) Provisional application No. 63/575,989, filed on Apr. 8, 2024.

(51) Int. Cl. H04L 9/40; H04L 9/00

(52) U.S. Cl. CPC H04L 63/0428; H04L 9/008

(57) ABSTRACT

A system for content encapsulation and secure communication of content includes: a data agency manager configured to facilitate communication of content from a content owner computing device to a user computing device based at least in part on defined governance logic for the content; a data encapsulation layer in communication with the data agency manager, the data encapsulation layer configured to bind the content to the defined governance logic, wherein the content bound to the defined governance logic is associated with a digital agency capsule; and a communication layer in communication with the data agency manager, the communication layer configured to communicate one or more a digital agency capsules from the content owner computing device to the user computing device according to the defined governance logic in each a digital agency capsule.

### CROSS REFERENCE TO RELATED APPLICATIONS

This U.S. Non-Provisional Patent Application claims the benefit of U.S. Provisional Patent Application Ser. No. 63/575,989 titled “DIGITAL AGENCY CAPSULE ARCHITECTURE” filed Apr. 2, 2024, and Provisional Patent Application Ser. No. 63/573,346 titled “METHOD OF GENERATING AND COMMUNICATING A DIGITAL AGENCY CAPSULE” filed Apr. 2, 2024, the entire disclosures of which are hereby incorporated by reference.

### BACKGROUND

### Field of the Disclosure

Aspects of the present disclosure pertain to the field of digital content management, focusing on the secure and governed distribution of digital assets. Specifically, the present disclosure relates to a system for encapsulating digital content—such as images, videos, documents, artificial intelligence (AI)-generated materials, and executables (e.g., including operating system kernels, websites, applications, and the like)—alongside clearly defined governance policies that dictate the terms of access, usage, and distribution. The system facilitates and manages the secure communication and secure transmission (e.g., including management of the terms and conditions and the associated rules and execution of the rules) of this encapsulated content, ensuring its integrity, authenticity, and compliance with the established governance policies across various platforms and stakeholders. Additionally, the system of the present disclosure may be configured to manage access to groups of objects, individual objects, and to provide the ability to see, perceive, and/or have knowledge pertaining to one or many objects that are not part of an entity's access level.

### Description of Related Art

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.). Additionally, or alternatively, the user may access the cloud platform using a hybrid solution, where the management and access is across platforms (e.g., stored remotely and accessed locally). In one example, the cloud platform may support management solutions, such as sales, service, marketing, community, analytics, applications, and the Internet of Things.

In some cases, using a cloud platform may encounter one or more problems. For example, there may be a deficiency in an amount of control and transparency over data usage, ownership, and privacy when using the cloud platform (e.g., and/or accessing or scraping by AI entities, data brokers, web crawlers, and the like). Additionally or alternatively, security risks (e.g., data breaches) may be present when using a cloud platform and/or other data storage, data management, and data processing systems. For example, personal information (e.g., stored using cloud platforms) may be at risk of being stolen, being compromised, and/or being used for malicious intents. Additionally or alternatively, personal information may be commoditized without explicit consent from an individual or without benefit to the individual.

While described with reference to a cloud platform and using the cloud platform to handle storage, management, and processing of data (e.g., content as described herein), the described techniques herein may be related to, but supersede, other prior methods and systems of storage, transmission, and access (e.g., such as cloud systems, edge systems, server systems, personal computing systems, and other computing systems).

### SUMMARY

One aspect provides a system for content encapsulation and secure communication of content. The system includes a data agency manager configured to facilitate communication of content from a content owner to a user based at least in part on defined governance logic for the content; a data encapsulation layer coupled to the data agency manager, the data encapsulation layer configured to bind the content to the defined governance logic, wherein the content bound to the defined governance logic comprises a self-contained unit; and a communication layer coupled to the data agency manager, the communication layer configured to communicate one or more self-contained units from the content owner to the user according to the defined governance logic in each self-contained unit.

Other aspects provide: one or more apparatuses operable, configured, or otherwise adapted to perform any portion of operations of the system described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any operations of the system described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors (e.g., or any type of processor or processors, including but not limited to central processing units (CPUs); graphics processing units (GPUs); digital signal processors (DSPs); neural processing units (NPUs); tensor processing units (TPUs); field-programmable gate arrays (FPGAs); application-specific integrated circuits (ASICs); trusted platform modules (TPMs); secure enclave processors; hardware security modules (HSMs); microcontrollers (MCUs); network processors; quantum processors; and processors deployed in cloud, edge, or virtualized environments, including container-based and multitenant architectures. The processors may operate individually or in a distributed fashion across multiple devices, physical or virtual), and/or such that performance may be by only one apparatus or in a distributed fashion or a federated fashion across multiple apparatuses); one or more computer program products embodied on one or more computer-readable storage media comprising code for performing any operations of the system described herein (e.g., such that code may be stored in only one computer-readable medium or across computer-readable media in a distributed fashion); and/or one or more apparatuses comprising one or more means for performing any portion of any operations of the system described herein (e.g., such that performance would be by only one apparatus or by multiple apparatuses in a distributed fashion).

By way of example, an apparatus may comprise a processing system, a device with a processing system, or processing systems cooperating and collaborating (e.g., hive and mesh) over one or more networks. An apparatus may comprise one or more memories; and one or more processors configured to cause the apparatus to perform any portion of any operations of the system described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example of a system for encapsulating content with defined governing logic for the content in accordance with aspects of the present disclosure.

FIG. 2 depicts an example system for encapsulating content with defined governing logic for the content in accordance with aspects of the present disclosure.

FIG. 3 depicts an example DAC architecture for encapsulating content with defined governing logic for the content in accordance with aspects of the present disclosure.

FIG. 4 depicts a block diagram of a system that supports encapsulating content with defined governing logic for the content in accordance with aspects of the present disclosure.

FIG. 5 depicts a diagram of a system including a device that supports encapsulating content with defined governing logic for the content in accordance with aspects of the present disclosure.

### DETAILED DESCRIPTION

Aspects of the present disclosure provide apparatuses, methods, processing systems, and computer-readable mediums for a digital agency capsule (DAC) that employs one or more encapsulation processes to bind content to governing logic defined for the content. For example, the one or more encapsulation processes may bind the content to use rules, lifecycle management protocols, and/or contractual terms for the content to form a DAC, and the DAC may be directly linked to an owner of the content. In some aspects, the DAC (e.g., encapsulated content that is bound to the defined governing logic) may ensure that, no matter where the content resides (e.g., in a cloud platform, on a remote server, on a device of the content owner, etc.), the content may remain under the control of its rightful owner and that the content is used strictly according to predefined terms (e.g., the defined governing logic).

In some aspects, the content may include one or more multimedia files (e.g., including images, audio files, videos, executable files, operating systems, applications, games, etc.) that can be encapsulated within a DAC, where the DAC may be configured or defined to protect artistic works, promotional materials, and personal media corresponding to the multimedia files from unauthorized access and alterations. Additionally or alternatively, the content may include textual content (e.g., documents, press releases, articles, social media posts, etc.) that can be encapsulated within a DAC, and the DAC may be configured or defined to ensures that textual representations of an individual or brand are distributed and used according to specified governance policies (e.g., the defined governing logic). Additionally or alternatively, the content may include software and/or code (e.g., software binaries, source code, applications, code for applications, etc.) that can be encapsulated within a DAC. And the DAC may be configured or defined to protect intellectual property (e.g., corresponding to the software and/or code) and ensure distribution of the software and/or code complies with licensing terms (e.g., the defined governing logic).

The DAC may address one or more technical problems in digital storage and/or digital communications, such as the lack of control and transparency over usage, ownership, and privacy of content (e.g., data). In an era where data breaches are commonplace and personal information is often commoditized without explicit consent or benefit to the individual, the DAC may introduce a paradigm shift by redefining how data is managed, accessed, and monetized. In current practices, content may escape the owner's control (e.g., an owner of the content) after the content is shared, leading to potential misuse and/or unauthorized access (e.g., or on a platform through nefarious access, and/or at a time of transport through “man-in-the-middle” attacks, and the like, any time the content is exfiltrated).

The DAC may employ encryption and cryptography processes and techniques. Through the use of advanced encryption techniques, the DAC may ensure that content is accessible only to parties who meet the specified conditions and/or access permissions (e.g., the defined governing logic) set by the content owner. This may protect the content from unauthorized access and may maintain its integrity by ensuring that any attempt to alter the content or its associated contract without permission corrupts the DAC, rendering the content inaccessible. This mechanism may enforce the bond between the content and its governance rules (e.g., the defined governing logic), making them inseparable and immutable.

In some aspects, the DAC may address a critical technical problem in the realm of identity and access management (IAM) by ensuring that access and usage of content are intrinsically tied to the identity of the user and governed by precise, pre-defined rules set by the data owner or agent (e.g., the defined governing logic). Traditionally, IAM systems have struggled to seamlessly integrate governance and user access controls for content, often resulting in either overly restrictive access policies that hinder legitimate utilization of content or too lenient controls that expose content to potential misuse. The DAC may overcome these challenges by embedding governance policies (e.g., the defined governing logic) directly within the content itself, making these policies inseparable from the content no matter where the content or DAC resides or how the content or DAC is accessed. This approach may simplify enforcement of access controls based on user identity and may also allow for dynamic adjustment of permissions in real-time based on compliance with these embedded rules (e.g., the defined governing logic). As a result, the DAC framework may offer a more granular, flexible, and secure method of managing access to digital assets (e.g., the content), ensuring that only authorized users can access content under conditions explicitly approved by the data owner, thereby enhancing both security and usability in digital ecosystems.

In some aspects, DAC and IAM systems may be fundamentally concerned with controlling access to digital assets and resources. DAC and IAM systems may implement security measures to ensure only authorized individuals or entities can access specific data or content. This shared focus on security and access control may reflect the roles of DAC and IAM systems in protecting sensitive information and intellectual property from unauthorized use or exposure. Additionally, both systems may aim to streamline and secure digital operations, whether related to content distribution in the case of the DAC systems or user access and permissions in the case of IAM systems.

The DAC may be primarily designed to encapsulate digital content and governance policies into a secure, self-contained unit. This approach ensures that the content and its usage rules travel together, regardless of where the content is stored or shared. The DAC focuses on the content, embedding rules for how the content can be accessed, used, and distributed, and applies regardless of the user's identity. IAM systems, on the other hand, may be focused on managing and verifying the identities of users and controlling their access to resources within a network or system. IAM systems do not concern themselves directly with the content but rather with who has access to the content, managing permissions based on roles, attributes, or group memberships. Additionally, the DAC may incorporate governance policies directly with the content, addressing compliance, usage rights, and distribution controls at the content level. The DAC may provide a mechanism for content creators to specify and enforce how their digital assets are used across different platforms. Alternatively, IAM systems may deal with governance and compliance from an identity perspective, ensuring access controls are in place to meet organizational policies and regulatory requirements. IAM systems may focus on authenticating users and authorizing access based on predefined policies.

Additionally, the DAC may employ advanced encryption techniques, digital signatures, and potentially blockchain technology to secure digital content and verify its authenticity and integrity. This DAC technology may be geared towards content protection, integrity verification, and policy enforcement. Alternatively, IAM systems may utilize authentication protocols, directory services, and access management policies to manage user identities and permissions. This IAM technology may be centered on user verification, password management, single sign-on (SSO) services, and multi-factor authentication (MFA). In some aspects, the DAC may be designed to be interoperable across various platforms and digital ecosystems, ensuring that encapsulated content and its governance policies are maintained irrespective of the distribution channel. The broad application of the DAC may encompass any digital content requiring protection and managed distribution. Alternatively, IAM systems must integrate with various information technology (IT) infrastructure components, applications, and services within an organization. While IAM may be crucial for securing access across different systems, its interoperability may focus on seamless user authentication and access management within organizational boundaries.

While the DAC and IAM systems may share a common goal of securing digital assets and resources, the DAC may be content-centric, embedding security and governance policies directly with the digital content. In contrast, IAM systems may be identity-centric, focusing on managing user identities and their permissions to access resources. Both play complementary roles in the broader digital security and data management context, addressing different aspects of the digital content and access control infrastructure.

The DAC may incorporate the concept of data agency for management of the content in the DAC, empowering individuals and organizations with control over their digital assets (e.g., the content). This control may extend beyond access permissions, enabling data agents to actively define and manage how their data is used throughout its lifecycle, which may be achieved by applying one or more Distributed Computing Environment (DCE) principles, which facilitate the distribution of DAC services across various platforms and networks, ensuring seamless and secure data access and control.

Further, the DAC may address a technical challenge of autonomous management of contractual data access terms based on predefined rules set by the data agent. This functionality, absent in traditional computing enclaves and other Digital Rights Management (DRM) solutions, may introduce a dynamic, autonomous control over data access, enhancing security and flexibility. The design of the DAC may emphasize portability and encapsulation, ensuring that data and its governance rules remain intact and enforceable, regardless of the storage location. This design may contrast with the dependency of traditional computing enclaves on specific hardware or system architecture, offering a more flexible and resilient solution to data management.

In solving these above described technical problems, the DAC may enhance data security and privacy and may open new avenues for data futures trade, monetization, and remuneration. By enabling data agents to set and manage terms for data access, the DAC may introduce a model where data access can be monetized through smart micro-payments, shifting the economic value of data towards owners of content. This may represent an improvement over traditional paywalls, subscriptions, and data licensing mechanisms, providing a fairer and more equitable economic model for data utilization.

Additionally, the DAC may solve a critical technical problem of ensuring data control, privacy, and monetization in the digital age. By encapsulating content with its use rules and contractual terms (e.g., defined governing logic), employing advanced encryption and cryptography for security of the content, and empowering data agents with unprecedented control over their digital assets, the DAC may represent a transformative approach to data management. This solution may protect data integrity and privacy, foster innovation, and create economic opportunities, enhancing governance of content that aligns with the values of transparency, security, and empowerment.

The DAC may offer customers unparalleled control and security over their content, marking a significant advancement in the way that personal and organizational content is managed and utilized. For customers, this may translate into a more secure digital experience, where the risk of data breaches and unauthorized access is greatly minimized. By integrating governance directly with the content itself, the DAC may ensure that customer data and/or content cannot be used without explicit adherence to predefined rules and conditions (e.g., the defined governing logic). This level of control may empower customers, allowing them to dictate the terms of usage, access, and lifecycle of the content. Such empowerment may be particularly relevant in today's data-driven world, where concerns over privacy and misuse of information are ever-present. Customers may benefit from the peace of mind that comes with knowing their content is protected by state-of-the-art encryption and cryptographic safeguards, ensuring their information remains confidential and secure.

Further, the DAC may include a dynamic permissions model, which hinges on the periodic refresh of a permit signal. Accordingly, the dynamic permissions model may offer customers an ongoing assurance that their content is being used in compliance with their stipulated terms (e.g., the defined governing logic). This real-time governance mechanism may be a proactive approach to data management, automatically revoking access if terms are breached or compliance reports are not submitted. For customers, this means that their content may remain in a protected state and may be accessible only under conditions the customers have approved or agreed to. This continuous, automated monitoring and enforcement of access permissions may significantly reduce the likelihood of unauthorized exploitation of the content, enhancing trust in digital transactions and interactions. Additionally, the DAC may adapt permissions in real time according to compliance status, which may simplify governance of the content for customers and also may represent a leap forward in protecting digital rights and autonomy.

Additionally, the economic advantages presented by the DAC may open new avenues for content owners (e.g., customers) to monetize their content in a secure and controlled manner. By allowing content owners to set specific terms for content access and usage, the DAC may facilitate a direct means of remuneration for the use of their content (e.g., data assets). This capability may foster a more equitable economic model where content owners can derive tangible benefits from their content, challenging traditional paradigms of content monetization dominated by large corporations. Additionally, the secure data sharing enabled by the DAC may catalyze innovation across industries, potentially leading to the development of new services and technologies that content owners can benefit from. This may enhance the value derived from their content and may also contribute to a more transparent, ethical, and innovative digital ecosystem, where the rights and interests of content owners are at the forefront.

In some embodiments, the DAC may comprise an architected as a secure, encapsulated digital container specifically designed to uphold rigorous data sovereignty, licensing compliance, and enforceable usage control of digital assets. Each DAC uniquely identifies its data asset and associated agent through a cryptographically secure DAC Ownership ID, established during an initialization phase. This DAC Ownership ID and embedded metadata describing licensing terms and conditions ensure that ownership and authorization are verifiable, immutable, and persistently enforced throughout the data lifecycle. The DAC system carefully preserves the original data attributes, explicitly maintaining original filenames and extensions, while seamlessly embedding DAC metadata, ensuring the user's interaction remains intuitive and imperceptible, with minimal friction in user workflows.

Operationally, the DAC lifecycle involves clearly delineated stages (e.g., initialization, configuration, instantiation, distribution, and/or ongoing management). During initialization and configuration, the data owner authenticates and credentials their identity, defining enforceable, immutable licensing terms through templates. Subsequent instantiation of the DAC occurs when specific digital assets are identified for encapsulation. The DAC may undergo a rigorous validation sequence, incorporating the DAC Ownership ID, asset metadata, and licensing terms to ensure completeness and accuracy prior to distribution or usage. Throughout distribution and subsequent interactions, the DAC Management System (DACMS) continuously monitors and validates user access, logging each interaction, and verifying adherence to licensing conditions in real-time. Continuous permission refresh cycles reaffirm authorization validity, effectively providing real-time enforcement and auditability.

Security within the DAC framework operates on multiple layers, encompassing both internal and external measures. Internally, the DAC employs encryption, authentication, and metadata tagging to ensure data integrity and confidentiality, protecting the content both at rest and in transit. Externally, DAC metadata is transparently communicated to users through intuitive mechanisms such as hover-over tooltips and context menus, clearly signaling DAC enablement and licensing requirements. Furthermore, the DAC mandates strict inheritance rules: any derivative or subsequent content incorporating DAC-protected assets automatically inherits the original terms and conditions, ensuring persistent protection. New licensing conditions applied to derivatives are permissible only if they provide more restrictive terms, preserving the fidelity and intent of the original data asset's licensing.

The DAC thus provides an integrated, comprehensive approach to digital asset protection, offering transparent, enforceable data control that preserves the agent's sovereignty across diverse digital platforms and ecosystems. Its architecture uniquely addresses current gaps in traditional digital rights and data management technologies by embedding enforceable metadata at the file level, integrating seamless user experience, rigorous compliance management, proactive security validation, and persistent ownership enforcement. This strategic combination of technical capability and usability ensures the DAC meets modern digital asset protection demands, effectively preventing unauthorized access, modification, or misuse, while providing the data owner unparalleled visibility and control throughout the data lifecycle.

The DAC system is architected to operate independently of underlying infrastructure, providing significant flexibility to customers across diverse deployment environments. While the DAC does not rely on specific hardware or software components, it can seamlessly integrate infrastructure-based accelerators, such as specialized hardware (e.g., including accelerators and FPGA, and the like) encryption modules or high-performance cryptographic services, to enhance operational performance when the customer desires. Furthermore, the security architecture of the DAC is intentionally modular, enabling customers to adopt a plug-and-play approach to security implementation. This modularity allows customers to integrate customized or preferred security solutions, including industry-standard encryption algorithms, third-party authentication modules, or specialized access control mechanisms, based on their unique regulatory or operational requirements. Additionally, key management within the DAC ecosystem offers exceptional flexibility: customers may choose simple key models provided directly by the system, rotating keys to periodically refresh cryptographic protection, multi-party keys where control is distributed across multiple stakeholders, or partial keys requiring collaborative assembly for data access. The DAC system also supports key expiration and revocation capabilities, enabling customers to proactively terminate access and securely close DAC-protected data assets, thus reinforcing data sovereignty and security throughout the entire digital content lifecycle.

In some embodiments, the DAC may be configured to support multiple data files encapsulated as individual objects within a single DAC container. Each file is independently managed with a unique ContentID, which distinctly identifies the asset within the DAC. This granular identification enables precise management of each object's metadata, permissions, and access keys. The DAC may comprise structured hierarchy and modularity, allowing data assets to be logically grouped into Data Asset Groups, each governed by tailored permission schemes and individualized terms and conditions. This modular permission scheme and management approach empowers DAC creators with the flexibility to define fine-grained, content-specific licensing, access control, and cryptographic keying, ensuring security and operational precision at the object level while maintaining broader DAC-level governance.

At the object level, each encapsulated data asset maintains dedicated cryptographic keys, individually configurable permissions, and customizable licensing terms. This allows the data agent to provide differentiated access ranging from fully restricted, limited-customized access, or broadly open access according to business, regulatory, or strategic needs. At the overarching DAC level, higher-level terms and conditions, permissions, and keys apply uniformly across all contained objects, enforcing universal standards or requirements. The interplay between DAC-level and object-level controls enables multi-tiered security and compliance enforcement, ensuring comprehensive protection that matches the nuanced requirements of each encapsulated data object and overall DAC strategy.

In some embodiments, the DAC architecture may be immutable. Once a DAC is instantiated and finalized, the DAC and its internal content objects, terms and conditions, cryptographic keys, permissions, and associated metadata cannot be altered or modified. This immutability ensures absolute integrity and authenticity of the encapsulated data and associated governance parameters throughout their entire lifecycle. Any changes or updates necessitate the creation of a new DAC instance, preserving an auditable and trustworthy history of data interactions. The immutable nature also ensures that licensing terms, compliance obligations, and data ownership rights remain consistently enforced, safeguarding data sovereignty and operational trust.

In some embodiments, the DAC may support extensive flexibility in key management and security implementation. Users can specify how cryptographic keys are handled, whether utilizing a simple, single-user key, rotating keys for enhanced security, partial keys requiring multi-party cooperation, or key expiry mechanisms to proactively revoke access. Security modules may be fully modular and pluggable, allowing customer-specific encryption algorithms, authentication mechanisms, or compliance protocols to be integrated. This infrastructure-independent approach ensures seamless DAC deployment across diverse computing environments, with optional support for accelerators or specialized security hardware if desired. The DAC may be configured to provide robust, precise, and adaptable data protection suitable for complex, multi-object data sovereignty scenarios.

In some embodiments, the systems and methods described herein may be configured to generate a DAC, accommodating user preferences and workflows. The systems and methods described herein may be configured to initialize an empty DAC without specifying or inserting the data assets it will protect. The systems and methods described herein may be configured to provision the DAC with all essential identifiers, licensing terms, cryptographic keys, permissions, and metadata frameworks, effectively creating a secure but open digital container ready to receive data at a future point. The DAC may be in an “open” state, prepared to accept content according to the owner's timeline and operational readiness. The systems and methods described herein may be configured to, responsive to receiving assets, securely encapsulate the assets within the already established DAC framework. The DAC inherits the predefined terms, conditions, and security mechanisms, immediately activating comprehensive protection and immutability enforcement. The systems and methods described herein may be configured to provide flexibility, allowing for time management and coordination separately from initial DAC setup activities.

In some embodiments, the systems and methods described herein may be configured to integrate data encapsulation directly and proactively with the DAC creation workflow. The systems and methods described herein may be configured to identify the specific digital assets requiring protection at the beginning of the process. The systems and methods described herein may be configured to initiate immediate preparation of data content, licensing terms, and permission association at the asset-level, organizing the data into structured, individually identifiable objects. The systems and methods described herein may be configured to, in response to desired terms and security mechanisms being defined, encapsulate the assets within the DAC concurrently with DAC creation, resulting in a fully instantiated and secured DAC after the process. This approach benefits users with clearly defined data protection goals upfront and prefer to establish full data sovereignty, licensing clarity, and enforceable access controls simultaneously with DAC instantiation, ensuring immediate and comprehensive protection of their digital assets.

In some embodiments, the DAC architecture delivers an extensive array of services and interfaces, designed for highly secure, adaptable, and seamless integration into existing and emerging environments. The DAC may leverage APIs for standard interactions, and/or may accommodate alternative interface types, including message queues, event streams, direct database connectors, and file-based interactions, based on customer preferences and integration requirements. This flexibility allows the use of DAC capabilities across diverse operational scenarios, infrastructures, and technology stacks, enhancing usability and integration simplicity. The DAC services systematically expose detailed metrics, telemetry, metadata, and other critical operational data necessary for precise control, continuous monitoring, and proactive governance.

In some embodiments, the DAC interfaces may provide comprehensive visibility into provenance, data ownership, data agency, and chain-of-custody, thereby ensuring transparency, auditability, and verifiable accountability throughout the entire lifecycle of digital assets. DAC generated telemetry and metrics support rigorous compliance validation, forensic audits, real-time transaction monitoring, and active license enforcement, further strengthening the integrity and trustworthiness of data transactions and interactions. By explicitly capturing and exposing these detailed provenance and metadata elements, the DAC may be configured to enhance organizational capabilities to confidently enforce data sovereignty, traceability, and governance standards across highly distributed, multi-party digital ecosystems.

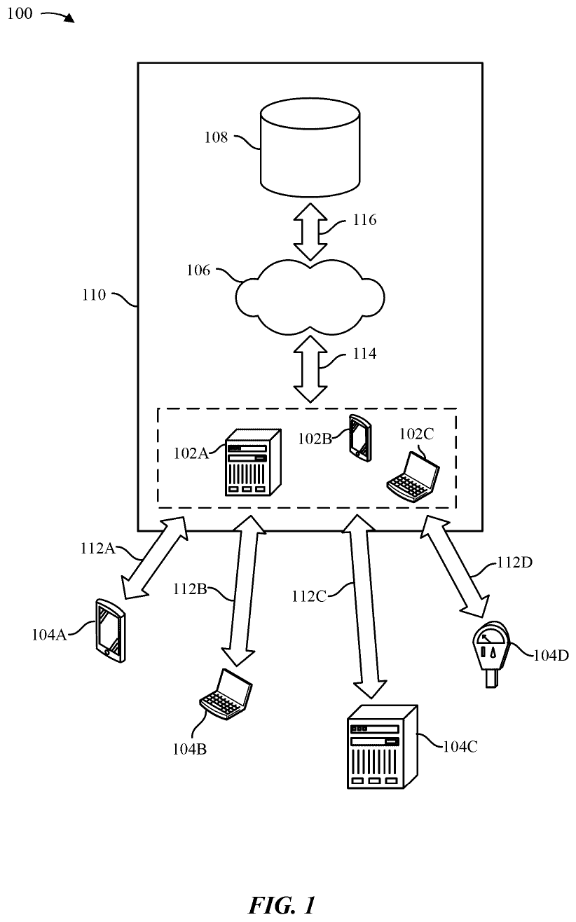

FIG. 1 illustrates an example of a system 100 for cloud computing that supports modifying default display configurations for objects in a user interface in accordance with various aspects of the present disclosure. The system 100 may include cloud clients 102, contacts 104, cloud platform 106, and data center 108. Cloud platform 106 may be an example of a public or private cloud network. A cloud client 102 may access cloud platform 106 over a network connection 114. The network may implement transfer control protocol and internet protocol (TCP/IP), such as the Internet, or may implement other network protocols. A cloud client 102 may be an example of a user device, such as a server (e.g., cloud client 102A), a smartphone (e.g., cloud client 102B), or a laptop (e.g., cloud client 102C). In other examples, a cloud client 102 may be a desktop computer, a tablet, a sensor, or another computing device or system capable of generating, analyzing, transmitting, or receiving communications. In some examples, a cloud client 102 may be operated by a user that is part of a business, an enterprise, a non-profit, a startup, or any other organization type.

A cloud client 102 may interact with multiple contacts 104. The interactions 112 may include communications, opportunities, purchases, sales, or any other interaction between a cloud client 102 and a contact 104. Data may be associated with the interactions 112. A cloud client 102 may access cloud platform 106 to store, manage, and process the data associated with the interactions 112. In some cases, the cloud client 102 may have an associated security or permission level. A cloud client 102 may have access to certain applications, data, and database information within cloud platform 106 based on the associated security or permission level and may not have access to others.

Contacts 104 may interact with the cloud client 102 in person or via phone, email, web, text messages, mail, or any other appropriate form of interaction (e.g., interactions 112A, 112B, 112C, and 112D). The interaction 112 may be a business-to-business (B2B) interaction or a business-to-consumer (B2C) interaction. A contact 104 may also be referred to as a user, a customer, a potential customer, a lead, a client, or some other suitable terminology. In some cases, the contact 104 may be an example of a user device, such as a smartphone (e.g., contact 104A), a laptop (e.g., contact 104B), a server (e.g., contact 104C), or a sensor (e.g., contact 104D). In other cases, the contact 104 may be another computing system. In some cases, the contact 104 may be operated by a user or group of users. The user or group of users may be associated with a business, a manufacturer, or any other appropriate organization.

Cloud platform 106 may offer an on-demand database service to the cloud client 102. In some cases, cloud platform 106 may be an example of a multi-tenant database system. In this case, cloud platform 106 may serve multiple cloud client 102 with a single instance of software. However, other types of systems may be implemented, including—but not limited to—client-server systems, mobile device systems, and mobile network systems. In some cases, cloud platform 106 may support CRM solutions. This may include support for sales, service, marketing, community, analytics, applications, and the Internet of Things. Cloud platform 106 may receive data associated with contact interactions 112 from the cloud client 102 over network connection 114 and may store and analyze the data. In some cases, cloud platform 106 may receive data directly from an interaction 112 between a contact 104 and the cloud client 102. In some cases, the cloud client 102 may develop applications to run on cloud platform 106. Cloud platform 106 may be implemented using remote servers. In some cases, the remote servers may be located at one or more data centers 108.

Data center 108 may include multiple servers. The multiple servers may be used for data storage, management, and processing. Data center 108 may receive data from cloud platform 106 via connection 116, or directly from the cloud client 102 or an interaction 112 between a contact 104 and the cloud client 102. Data center 108 may utilize multiple redundancies for security purposes. In some cases, the data stored at data center 108 may be backed up by copies of the data at a different data center (not pictured).

Subsystem 110 may include cloud clients 102, cloud platform 106, and data center 108. In some cases, data processing may occur at any of the components of subsystem 110, or at a combination of these components. In some cases, servers may perform the data processing. The servers may be a cloud client 102 or located at data center 108.

In some cases, using cloud platform 106 may encounter one or more problems. For example, there may be a deficiency in an amount of control and transparency over data usage, ownership, and privacy when using cloud platform 106. Additionally or alternatively, security risks (e.g., data breaches) may be present when using cloud platform 106 and/or other data storage, data management, and data processing systems. For example, personal information (e.g., stored using cloud platforms) may be at risk of being stolen, being compromised, and/or being used for malicious intents. Additionally or alternatively, personal information may be commoditized without explicit consent from an individual or without benefit to the individual

Encryption technologies have long been the cornerstone of content security, ensuring that content is unreadable to unauthorized parties. However, encryption alone does not solve the problem of ownership and control of content. Once content is decrypted for use, enforcing how the content is subsequently handled or shared is challenging.

DRM systems were introduced to address the issue of controlling and enforcing the rights over digital media. While DRM provides a means to restrict how digital content is accessed and used, it has been criticized for being overly restrictive and infringing on user rights. Additionally, DRM systems often rely on specific hardware or software environments, limiting their flexibility and portability.

Another approach to enhancing content privacy and security has been previously employed through using secure computing environments, such as trusted execution environments (TEEs) and hardware security modules (HSMs). These technologies provide a secure space for processing sensitive information, protecting the sensitive information from unauthorized access even if the system is compromised. However, these solutions are typically tied to specific hardware, making them less adaptable and potentially creating silos of secure content that are difficult to integrate.

Blockchain technology has also been touted as a solution for ensuring content integrity and facilitating secure, transparent transactions. While blockchain offers immutability and transparency, it does not inherently provide privacy, and the public nature of many blockchains can lead to challenges in managing content ownership and control in a nuanced manner.

Accordingly, as described herein, a DAC is provided that may use an advanced data encapsulation technology to seamlessly merge content with its governance framework (e.g., defined governing logic and/or one or more governing policies), including usage policies, lifecycle management rules, and contractual terms. This encapsulation may ensure that the governance mechanisms are intrinsically linked to the content, regardless of where the content resides or how the content is used. Integration of the content with its control parameters may be facilitated through sophisticated encryption and cryptographic techniques, which safeguard integrity and confidentiality of the content. The DAC may also enable the autonomous enforcement of access and usage rules set forth by the content owner or agent, thereby establishing a secure and controlled environment for handling content that respects ownership rights and privacy considerations.

The DAC may employ a dynamic permissions model operationalized through a periodic refresh of a permit signal to maintain continuous compliance with the agreed-upon terms of use. This dynamic permissions model may hinge on real-time communication (e.g., near real-time, periodic, on request, push-pull, etc.) between a user's system and a content owner or agent's system to verify adherence to the contractual terms. In some aspects, compliance may be evidenced by regular reports from the user's system, which may in turn sustain the permit signal that allows access to content. Failure to provide these reports or a breach of contract terms may result in an automatic revocation of the permission signal, rendering the content inaccessible and the DAC in a deny state. This mechanism may ensures that content usage consistently aligns with the owner's stipulations, fostering a trust-based relationship between content owners and users.

The underlying technological infrastructure of the DAC may incorporate secure communication protocols to facilitate the exchange of compliance reports and the management of the permission signal. Cryptography may protect these communications and ensure that the permit signal and compliance status are transmitted securely and remain tamper-proof. This infrastructure may support a responsive and adaptive governance model that can adjust permissions in real-time (e.g., near real-time, periodic, on request, push-pull, etc.) based on compliance status, offering a significant advancement over static, manual data management practices. The core technology of the DAC (e.g., with its emphasis on data encapsulation, dynamic permissions, and secure communications) may present a transformative approach to data privacy, security, and ownership, promising a more ethical and equitable digital future.

In some aspects, the DAC may provide a robust solution that aligns seamlessly with global and regional data protection regulations such as the General Data Protection Regulation (GDPR) in the European Union, the California Consumer Privacy Act (CCPA) in the United States, and the Health Insurance Portability and Accountability Act (HIPAA). By design, the DAC may enhance compliance with these regulations through its inherent data protection, privacy, and governance mechanisms.

Under GDPR, the DAC may offer a structured approach to data management that prioritizes user consent, data minimization, and the right to erasure-all key principles of GDPR. The ability of the DAC to encapsulate content with its governance may ensure that content (e.g., personal data) is not just protected but that its usage strictly adheres to the conditions set by the content subject. This direct integration of governance with the content may address GDPR requirements for explicit consent and purpose limitation by enforcing access and usage rules as defined by the content owner. Further, the DAC may include a dynamic permissions model (e.g., which allows for real-time revocation of data access) to empower individuals with the right to withdraw consent, effectively enabling the content to revert to an inaccessible state, thereby facilitating compliance with the right to erasure or “right to be forgotten.”

In the context of CCPA, the DAC may enhance the rights of California residents by providing greater control over personal information. The CCPA emphasizes consumers' rights to know about, delete, and opt-out of the sale of their personal information. The DAC may include a governance model to ensure that content owners can easily enforce these rights, as the content and its use conditions are inseparably linked. By allowing content owners to specify and enforce the terms under which their information is accessed and used, the DAC may inherently support the CCPA's aim to empower consumers regarding their personal data. The transparency and control mechanisms of the DAC may align with the CCPA's goals, offering a proactive approach to privacy that can significantly reduce the complexity and cost of compliance for organizations.

Regarding HIPAA, which sets the standard for protecting sensitive patient data in the United States, the DAC may ensure that healthcare information is handled with the utmost security and privacy. The encryption and data governance capabilities of the DAC may ensure that PHI (Protected Health Information) is accessed and used strictly in accordance with HIPAA requirements. By encapsulating PHI with its access and usage policies, the DAC may enforce strict controls on who can access the information and under what conditions, addressing HIPAA's requirements for safeguarding patient data. Additionally, the real-time permission model of the DAC may allow for immediate revocation of access in the event of a policy violation, further securing PHI against unauthorized use and disclosure.

As such, the DAC may provide a comprehensive framework that not only meets but exceeds the privacy and security standards set by regulations like GDPR, CCPA, and HIPAA. The management of content provided by the DAC may offer a forward-thinking solution to the complex challenges of data protection compliance, promising a more secure and privacy-centric digital landscape.

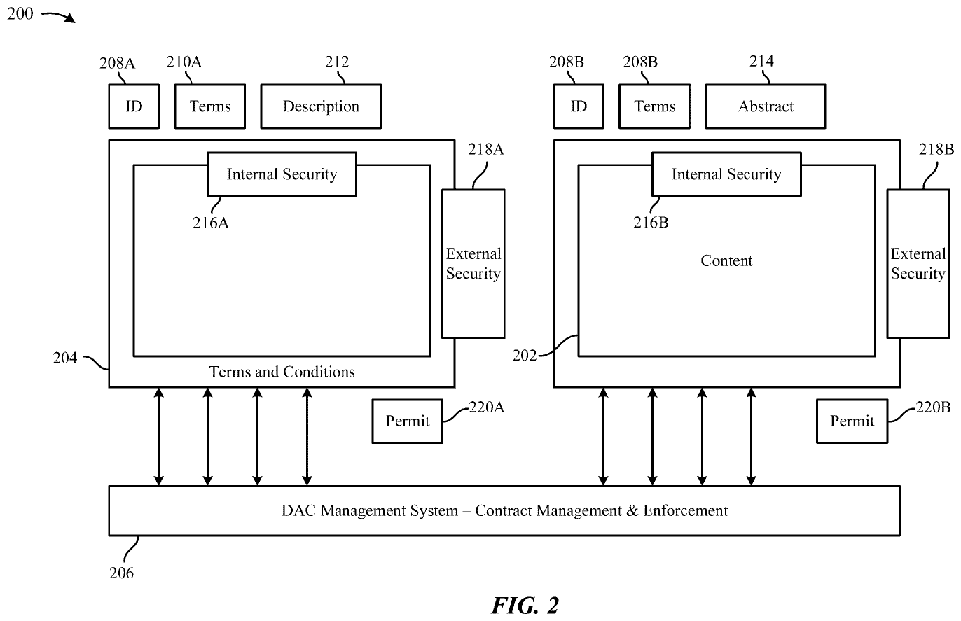

FIG. 2 depicts an example system 200 for encapsulating content with defined governing logic for the content in accordance with aspects of the present disclosure. For example, the system 200 may represent a DAC (e.g., a self-contained unit) as described herein, where the DAC is configured to bind a content 202 with governing logic 204 defined for the content 202 (e.g., terms and conditions for accessing, using, and/or sharing the content 202) into a single self-contained unit. The system 200 may include a DAC management system 206. In some aspects, the DAC management system 206 may manage one or more DACs (e.g., for one content owner and/or across multiple content owners) and enforce compliance of accessing, using, and/or sharing content in the one or more DACs according to the governing logic defined for each DAC.

In some aspects, the content 202 and the governing logic 204 may include and/or may be linked to an identifier (ID) 208 and terms 210. For example, the ID 208 may be an ID configured by and/or assigned to an owner of the content 202 (e.g., the content owner). The terms 210 may include general terms that apply to a plurality of content of the content owner. In some aspects, the governing logic 204 may include and/or may be linked to a description 212 (e.g., provided by the content owner) that describes what is covered by the governing logic 204. In some aspects, the content 202 may include and/or may be linked to an abstract 214 that briefly describes the content 202.

In some aspects, the content 202 may include different types of digital content. For example, the content 202 may include multimedia files (e.g., where the DAC can protect artistic works, promotional materials, and personal media from unauthorized access and alterations), textual content (e.g., where the DAC can ensure that textual representations of an individual or brand are distributed and used according to specified governance policies), software and/or code (e.g., where the DAC can potentially encapsulate software binaries or source code to protect intellectual property and ensure software distribution complies with licensing terms), or another type of digital content not explicitly listed herein.

In some aspects, the multimedia files may include visual content (e.g., images, photographs, infographics, visual data representations, branding materials, logos, trademarks, etc.), audio content or files (e.g., music tracks, albums, podcast episodes, audio clips for use in multimedia presentations or as standalone content, etc.), and/or video content (e.g., promotional videos, advertisements, trailers, educational videos, instructional videos, behind-the-scenes footage, interviews, documentary content, etc.). Additionally or alternatively, the textual content may include documents (e.g., articles, blog posts, press releases, eBooks, reports, white papers, scripts for speeches, scripts for presentations, scripts for video content, etc.) and/or social media content (e.g., posts, stories, social media campaigns, social media advertisements, updates intended for social media platforms, such as Instagram, Facebook, and LinkedIn, etc.).

Additionally or alternatively, the software and/or code may include interactive content (e.g., web applications and tools, games and interactive experiences, virtual reality (VR) and augmented reality (AR) content, etc.), software and applications (e.g., mobile applications, desktop applications, firmware and embedded systems, etc.), digital documents (e.g., contracts, agreements, licensing documents, instruction manuals and guidelines, research papers and academic articles, etc.), datasets (e.g., research data, customer data with appropriate privacy measures, financial data and reports, etc.), and/or web content (e.g., entire websites, specific web pages, webinar recordings, online course materials, etc.).

In some aspects, the content 202 may also include functions and/or artificial intelligence (AI)/machine learning (ML) operational elements. For example, the DAC may encapsulate trained ML models (e.g., including ontologies, intent elements, digital twin representation, and associated data), including their parameters and the data they were trained on, which may allow for the secure sharing and deployment of AI models, ensuring that the model's integrity is preserved and that the model is used in accordance with specified governance policies. Additionally or alternatively, content generated by AI (e.g., such as articles, music, or art) may also be included within a DAC, which may ensure that AI-generated works are attributed correctly and used under the terms of the creator to address copyright and usage rights in the AI era. Additionally or alternatively, the DAC may encapsulate functions (e.g., especially those used in serverless architectures or cloud-based services) to enable secure and controlled execution of code snippets, which may be particularly useful for deploying AI or data processing algorithms with defined usage restrictions. Additionally or alternatively, incorporating executable code or functions within a DAC may open up possibilities for distributing software or algorithms with embedded usage policies, which may be useful for sharing proprietary algorithms under specific conditions or for academic purposes where research methods must be shared securely. Additionally or alternatively, the DAC may encapsulate AI models to enable sharing and using ML models to allow creators to specify how their models can be utilized, which may ensure that users adhere to ethical guidelines and usage terms and acknowledge the creators appropriately.

Additionally or alternatively, the DAC may encapsulate datasets (e.g., which may be crucial for AI and ML) to secure the data and control its usage, which may be important for sensitive or proprietary data used to train ML models, ensuring that data privacy and proprietary rights are maintained. For example, the DAC may be configured to track when one of its protected files is used as input to an AI model; monitor how many tokens are created from that content; apply rules—such as limiting the number of tokens, restricting the use of those tokens to inference only (not training), or specifying that the tokens can only be used for a certain period of time; specify what kinds of models or systems are allowed to use those tokens (for example, open vs. closed-source models); generate a log or telemetry entry each time a tokenization event happens, including details about which DAC was involved, which content was used, which model processed it, and for what purpose; and, if necessary, revoke access to prevent further use if those rules are violated (e.g., which may ensure that, even if the actual content isn't visible anymore-just tokens inside a model, the DAC can still enforce the original licensing terms, retain traceability, and maintain control). The DAC serves as a gatekeeper not just for the file itself, but for the abstracted representations of the file that AI systems use. Additionally or alternatively, the DAC may encapsulate ML operations components (e.g., training pipelines, model evaluation tools, and deployment mechanisms) that standardize, define, and/or secure a lifecycle of an ML model, such that creators of the ML models can enforce governance over how their AI solutions and/or ML models are deployed, scaled, and maintained. Additionally or alternatively, the experiences and environments created using VR and AR technologies may be encapsulated in DACs to ensure that immersive content is used and distributed according to the creator's intentions, preserving the authenticity of virtual experiences. Additionally or alternatively, while DACs may function independently of blockchain technology, encapsulating blockchain smart contracts within DACs may offer ways to automate and securely enforce content usage rights and transactions.

The DAC may provide enforceable, policy-bound control over digital content, particularly when that content is processed by AI systems such as Large Language Models (LLMs) or Large Context Models (LCMs). When a DAC-protected data asset is ingested into such a model, the DAC does not simply embed an invisible marker or passive signal (as in watermarking); rather, it enforces real-time governance over the creation and use of the tokens that the model derives from the content. In an LLM or LCM context, tokens represent the model's internal representation of the content, these are the fundamental computational units used during inference, training, and context construction. The DAC monitors and controls this transformation by ensuring that tokenization of its contents occurs only under predefined, enforceable terms: who may tokenize the content, how many tokens may be created, whether those tokens can be used for training or inference, for how long, in which systems, and with what downstream restrictions. Furthermore, the DAC can log tokenization events, associate each token stream with metadata such as the data agent, provenance chain, and usage purpose, and even revoke future access dynamically. The DAC architecture treats these tokens not as detached abstractions, but as extensions of the protected content, subject to the same licensing, ownership, and compliance boundaries as the original asset. In contrast, watermarking embeds invisible signals or patterns into content, either in the text itself or in some latent form, before it is ingested into a model. The DAC allows for post-hoc detection (e.g., whether a model was trained on specific content), but does not prevent tokenization, does not enforce access rules, and cannot govern token-level behavior in real time. Watermarks also degrade under transformation (e.g., paraphrasing, compression, fragment recombination) and are often not resilient or legally enforceable. More importantly, watermarks do not convey permission, they merely imply origin. In contrast, the DAC asserts explicit control: before tokenization occurs, access must be granted, terms must be accepted, and telemetry is captured. While watermarking is a signal of provenance, the DAC is an instrument of sovereignty, ensuring that any use of the content, including its transformation into LLM or LCM tokens, is authorized, measurable, reversible (through access revocation), and attributable through a chain of custody. This enables token-level accountability and auditability that watermarking fundamentally cannot provide.

The architecture for the DAC may include an integration of several key technologies and principles to ensure that the DAC delivers secure, controlled, and compliant management of content. At its core, the DAC architecture may be built upon the principles of data encapsulation, advanced encryption, dynamic permissions, and secure communication protocols and may be structured to support scalability, flexibility, and interoperability across diverse digital ecosystems. For example, the DAC may offer a versatile and flexible approach to encapsulating content, allowing for the portability of the DAC across different platforms and environments without compromising the integrity of the governance policies (e.g., the governing logic 204). This means that regardless of where the DAC is stored or how the DAC is accessed, the governance policies may remain active and enforceable, ensuring continuous compliance and control.

In some aspects, this architecture may be particularly advantageous in distributed digital ecosystems, where content often traverses multiple environments and systems. The use of containerization may ensure that the governing logic 204 of the DAC (e.g., the DAC's governance policies) are always in effect, providing a consistent layer of security and control that travels with the content 202, thereby significantly reducing the risk of policy violation or data misuse.

In some aspects, the DAC architecture may include a secure data encapsulation layer for encapsulating the content 202. For example, the secure data encapsulation layer may tightly couple the content 202 with the governing logic 204 (e.g., associated governance policies and/or terms and conditions, including usage rules, lifecycle management instructions, and contractual terms). Each DAC may use advanced containerization technologies to generate a self-contained unit with embedded governance logic (e.g., the governing logic 204) that dictates how the content 202 can be accessed, shared, and used. This encapsulation ensures that governance policies are inseparable from the data, thus enforcing compliance and control directly at the data level. For example, the secure data encapsulation layer may be a framework designed to merge the content 202 with its governing logic 204 seamlessly.

This integration of the content 202 and the governing logic 204 may be achieved through the use of advanced encapsulation technologies, which enable the DAC to function as a self-contained unit. Within each DAC, the content 202 is not simply stored; the content 202 may be interwoven with embedded governance logic (e.g., the governing logic 204) that comprehensively outlines the conditions under which the content 202 can be accessed, shared, and utilized. This embedded governance logic may include detailed usage rules, lifecycle management instructions, and contractual terms tailored to specifications of an owner or agent of the content 202. By binding these policies directly with the content 202, the secure data encapsulation layer may ensure that any interaction with the content 202 (e.g., access, sharing, utilization, etc.) can only occur within the parameters set by the governing logic 204 (e.g., the embedded rules), thus maintaining strict compliance and control at the data level.

The secure data encapsulation layer may employ encapsulation technologies for isolating the content 202 and embedding the governing logic 204 into the content 202, itself. For example, the DAC may encapsulate digital content (e.g., documents, images, videos, artificial intelligence (AI) models, etc.) with its governance policies, binding the content 202 with its usage rules, lifecycle management instructions, and contractual terms. This encapsulation may create a secure and self-governing unit (e.g., self-contained unit) that enforces the governing logic 204 (e.g., defined by the content owner) directly at the data level (e.g., that goes beyond mere encryption or access control lists).

The secure data encapsulation technologies employed for generating a DAC may share some underlying principles (e.g., isolating resources and providing a defined execution environment) with traditional containerization or virtualization technologies, such as hypervisors, VMs (Virtual Machines), and Docker containers. However, DAC encapsulation may significantly differ in its purpose, functionality, and the problems it aims to solve, particularly in the realm of digital asset management and security.

For example, the principles shared by the secure data encapsulation technologies employed for generating a DAC and traditional containerization or virtualization technologies may include both DACs and traditional technologies (e.g., Docker or VMs) provide a form of isolation. For VMs and containers, the isolation may occur at the system or application level, separating different computing environments within a same physical infrastructure, and DACs may isolate digital content and its governance policies, creating a secure, self-contained unit. Additionally, like traditional technologies (e.g., Docker containers, which are known for their portability across different computing environments), DACs may encapsulate digital content and policies in a way that can be transported and recognized across various platforms, maintaining its integrity and the enforcement of its associated rules.

However, the secure data encapsulation technologies employed for generating a DAC may differ from the traditional containerization or virtualization technologies. For example, traditional containerization and virtualization technologies are primarily focused on isolating computing environments to improve deployment efficiency, scalability, and resource utilization. That is, traditional containerization or virtualization technologies may serve infrastructure and development operational needs. On the other hand, DAC encapsulation may be focused on securing digital content (e.g., documents, media files, AI models, etc.) and ensuring that its use complies with predefined governance policies. That is, DAC encapsulation may focus more on content management and security, rather than computing resource optimization.

Additionally or alternatively, DACs may uniquely bind digital content with its governance policies, enabling direct enforcement of usage rules, access controls, and lifecycle management instructions at the data level. This may include capabilities for real-time policy adjustment, monitoring, and compliance verification, which are not inherent to containerization or virtualization technologies. For example, VMs, hypervisors, and containers lack built-in mechanisms for governing how contained applications or systems interact with digital content from a legal or compliance standpoint. Additionally or alternatively, while VMs, hypervisors, and containers include security features aimed at protecting the computing environment and ensuring the safe execution of code, DACs may incorporate advanced encryption (e.g., including homomorphic encryption), digital signatures, and potentially blockchain technologies for content integrity verification and provenance tracking. These features may focus on securing the content itself and ensuring adherence to governance policies.

Additionally or alternatively, DAC encapsulation may be content-centric from creation to distribution and use (e.g., designed specifically to protect and manage digital assets throughout their lifecycle). On the other hand, traditional containerization and virtualization solutions are infrastructure-centric, aiming to abstract, optimize, and manage computing resources such as CPU, memory, and storage for applications. Additionally or alternatively, DACs may integrate AI and machine learning for real-time content monitoring, unauthorized alteration detection, and predictive analytics regarding brand impact, where this level of content-focused intelligence may be beyond the scope of traditional containerization or virtualization technologies.

At the core of the secure data encapsulation layer for the DAC is enforcing compliance and control directly at the data level. This approach may represent a paradigm shift in data management, where traditional systems typically apply governance mechanisms at the system or platform level, often leading to gaps in enforcement and inconsistencies in policy application. By integrating the governance policies (e.g., the governing logic 204) within the content 202 itself, the DAC may ensure that these governance policies are omnipresent, automatically enforcing compliance regardless of a location of the content 202 or the system on which the content 202 resides. This integration may streamline the enforcement of data governance and may also empower content owners with unprecedented control over their content (e.g., data assets). The embedded governance logic within each DAC may act as a guardian of the data owner's interests, ensuring that the use of the content 202 aligns with the owner's intentions.

In some aspects, the encapsulation technology implemented for the DACs may support dynamic access control, which may allow content owners to modify access rights and governance policies in real-time based on specific conditions and/or user behaviors. This flexible and autonomous control mechanism may enable adaptations to changing contexts and user interactions without compromising security or governance. Additionally, the DAC may integrate AI and/or ML to allow for advanced content analysis, usage monitoring, and predictive modeling regarding distribution and impact (e.g., of the DAC and/or the content 202). This capability may enable the DAC to learn from interactions and adapt its governance mechanisms accordingly for digital asset management.

The DAC architecture may further include distinct separation and encryption of a data contracts layer (e.g., for the content 202) and a data access layer (e.g., for the governing logic 204), each requiring independent decryption and authorization processes for access to a DAC. This dual-layer encryption strategy may strengthen the security posture of the DAC by adding an additional layer of protection and may also delineate the governing logic 204 or governance (e.g., contract) from the content 202 or actual usage of the content 202 (e.g., access), ensuring that each can be managed and secured according to its specific needs and sensitivities. The separation may allow for a granular control over access, where permissions can be precisely tailored and adjusted for the contract terms (e.g., the governing logic 204) independently of the content 202 itself.

The cryptographic linkage between these two layers may be designed using the ID 208 (e.g., corresponding to the content owner or content agent) and elements of the content 202 and/or the governing logic 204 to generate a unique hash, which in turn produces a distinct key for each layer for every aspect of the content 202 within the DAC. This method of generating unique keys based on the content 202 and its governance policies (e.g., the governing logic 204) may ensure that the encryption is robust and also personalized to a specific data item and its associated terms. This unique cryptographic binding may serve multiple purposes. For example, the cryptographic binding may reinforce the integrity of the content 202 and its governing logic 204 by ensuring that any attempt to tamper with either layer can be immediately detected and invalidated. Additionally, the cryptographic binding may facilitate a streamlined verification process for accessing the content 202, as the unique hash key ties the authorization directly to the specific conditions set by the content owner.

Accordingly, encryption and cryptographic services may form a next layer of the DAC architecture. Every piece of data within a DAC is encrypted using state-of-the-art cryptographic algorithms for an internal security 216, ensuring that the governing logic 204 remains confidential and tamper-proof (e.g., via an internal security 216A) as well as ensuring the content 202 remains confidential and tamper-proof (e.g., via an internal security 216B). This layer also employs digital signatures to maintain the integrity of the data and its associated governance policies, facilitating secure and verifiable transactions. For example, each DAC may include digital signatures and may potentially leverage blockchain or blockchain-like technologies for immutable provenance tracking. The digital signatures and immutable provenance tracking may ensure authentication of the content 202 and its source and may ensure that any alterations to the digital asset (e.g., the content 202 and/or the governing logic 204) can be detected, offering integrity verification and content authentication. Additionally, the DAC may incorporate quantum-resistant encryption algorithms to future-proof digital assets against potential quantum decryption threats.

By employing state-of-the-art cryptographic algorithms, each piece of content within a DAC may also be encrypted for an external security 218, rendering the content 202 confidential and secure from potential breaches. For example, the governing logic 204 may be encrypted for an external security 218A, and the content 202 may be encrypted for an external security 218B. This encryption may ensure that even if the content 202 were to be intercepted or accessed without permission, the content 202 would remain indecipherable and useless to the attacker because the attacker does not possess the permission to gain access to a permission signal 220 that is necessary to gain access of the content 202 from the content owner (e.g., a permission signal 220A for the governing logic 204 and a permission signal 220B for the content 202, or a single permission signal for both the governing logic 204 and the content 202). Additionally, this layer may utilize digital signatures, a critical component in maintaining the integrity of both the data and its embedded governance policies (e.g., for the internal security 216 and/or the external security 218). Digital signatures may provide a means for secure and verifiable transactions, enabling content recipients (e.g., users) to confirm the authenticity of the content 202 and ensuring that the content 202 has not been altered in transit. This dual approach of encryption and digital signature deployment may fortify the DAC against both external breaches (e.g., via the external security 218) and internal misuse (e.g., via the internal security 216), establishing a secure foundation for data handling and exchange.

In some aspects, the layer for encryption and cryptographic services may incorporate and/or use homomorphic encryption (e.g., partially homomorphic encryption (PHE), somewhat homomorphic encryption (SHE), fully homomorphic encryption (FHE), levelled homomorphic encryption (LHE)) to enhance the utility and security of the DAC. Homomorphic encryption may include cryptographic techniques that allow for computations to be performed on encrypted data (e.g., the content 202), without needing to decrypt the encrypted data first. This capability may be transformative to enable the DAC to support secure data processing and analysis in encrypted form, thereby maintaining privacy and confidentiality of the content 202 even during use. The inclusion of homomorphic encryption may broaden the applicability of the DAC in sensitive fields such as healthcare and finance, where data and/or content can be analyzed and utilized without exposing the underlying sensitive information. Further, homomorphic encryption may underpin the data sovereignty and control in the DAC, as homomorphic encryption may ensure that the content 202 remains encrypted and protected throughout its lifecycle, even when being actively processed. Using homomorphic encryption may elevate the security measures within the DAC architecture and may also open avenues for secure data utilization.

Additionally or alternatively, the layer for encryption and cryptographic services may incorporate and/or use other encryption algorithms. For example, the other encryption algorithms may include a multi-party computation (MPC) algorithm, an advanced encryption standard (AES) algorithm, a triple data encryption standard (DES) algorithm, Rivest-Shamir-Adleman (RSA) algorithm, Elliptic Curve Cryptography (ECC), ChaCha20, Twofish, Quantum Key Distribution (QKD), Post-Quantum Cryptography Algorithms, Secure Hash Algorithm 3 (SHA-3), Blowfish, Camellia, CAST-128/CAST5, CAST-256/CAST6, Serpent, International Data Encryption Algorithm (IDEA), Threefish, McEliece Cryptosystem, NewHope, or another encryption algorithm not expressly listed herein. Additionally or alternatively, the layer for encryption and cryptographic services may incorporate and/or use other technologies similar to homomorphic encryption or in addition to homomorphic encryption, such as bootstrapping, noise growth, MPC, etc.

In some aspects, the DAC architecture may include a dynamic permissions model. For example, the dynamic permissions model may include and/or use cryptographic techniques to generate and manage a periodic refresh of permit signals (e.g., the permission signal(s) 220). The dynamic permissions model may include a secure handshake mechanism between a system of a user (e.g., accessing, utilizing, and/or sharing a DAC) and a system of the content owner or content agent, where the handshake mechanism is configured to validate compliance with the agreed-upon terms and conditions (e.g., the governing logic 204). In case of non-compliance or a breach of contract, the architecture (e.g., via the dynamic permissions model) may automatically revoke the permit signal, leveraging cryptographic protocols to transition the content 202 and/or DAC into a deny state.

The dynamic permissions model within the DAC architecture may introduce a mechanism for managing data access rights, underpinned by robust cryptographic techniques. For example, the techniques and mechanisms of the dynamic permissions model may be instrumental in generating and managing the periodic refresh of permit signals, which may be a core component that enables real-time (e.g., near real-time, periodic, on request, push-pull, etc.) governance over access to the content 202. As described previously, this process may be facilitated through a secure handshake mechanism between the system of the user and the system of the content owner or content agent, ensuring that access to the content 202 is contingent upon continuous validation of compliance with the established terms and conditions (e.g., the governing logic 204). In instances where compliance is not met or a breach of contract occurs, the dynamic permissions model and/or DAC architecture may be designed to automatically revoke the permit signal. This revocation may be executed using cryptographic protocols, which may effectively transition the content 202 and/or DAC back into its natural deny state, preventing any unauthorized access or use. The dynamic permissions model may reinforce the security of data transactions and may ensure that governance of the content 202 is dynamically aligned with stipulations from the content owner, offering a flexible yet secure approach to data access management.

In some aspects, the dynamic permissions model may incorporate homomorphic encryption (e.g., partial homomorphic encryption, FHE, etc.), as described previously, to further enhance its capabilities by allowing computations to be performed on encrypted data without decrypting the encrypted data. For example, the validation of compliance, the refreshing of permit signals, and the enforcement of access controls may be conducted on content 202 that remains in its encrypted state, thereby offering an additional layer of security. The use of homomorphic encryption in this context may provide the DAC architecture by ensuring that data privacy is maintained even during the process of access control and compliance checks. Additionally, homomorphic encryption may facilitate a higher level of data utility while still adhering to strict privacy standards, as homomorphic encryption may allow for meaningful operations on encrypted data. This integration of homomorphic encryption into the dynamic permissions model of the DAC may fortify the architecture against potential security breaches and may also maximize the utility of encrypted data, ensuring that the DAC architecture remains at the forefront of privacy-preserving technologies in data management. Additionally or alternatively, the dynamic permissions model may incorporate one or more other encryption algorithms as provided previously.

In some aspects, the DAC may include a communication layer. At the communication layer, secure channels may facilitate the exchange of compliance reports and permit signal refresh requests between the systems of the user(s) and the content owner(s). For example, the communication layer may use secure communication protocols, such as Transport Layer Security (TLS), to ensure that all data transmissions are encrypted and authenticated. Additionally, the communication layer may be responsible for the real-time (e.g., near real-time, periodic, on request, push-pull, etc.) monitoring and management of access permissions based on the continuous assessment of compliance status.

In some aspects, the described DAC architecture may support interoperability through application programming interface (API) gateways or blockchain-based smart contracts (as needed), enabling seamless integration with existing systems and platforms while ensuring the secure and efficient exchange of information. For example, the DACs may be communicated across, integrated with, and/or interfaced through one or more external systems, such as a publishing and subscribing (PubSub) system, RESTful APIs, GraphQL, WebSocket, Server-Sent Events (SSE), SOAP, MQTT, AMQP, gRPC, a really simple syndication (RSS)/Atom Feeds, Webhooks, Odata, CoAP, JSON-RPC, XML-RPC, STOMP, SignalR, Apache Kafka, RSocket, ZeroMQ, or another external system not expressly listed herein.

Additionally or alternatively, for the described DAC architecture, the DACs may be communicated across, integrated with, and/or interfaced though quantum-secured communication channels, quantum computing APIs, adaptive AI interfaces, AI-generated content distribution, autonomous edge computing interfaces, natural language processing (NLP) enhanced interfaces, neural interface technology, AI-driven predictive analytics interfaces, quantum-enhanced optimization for real-time systems, self-learning systems, biometric interaction interfaces, emotional recognition and response systems, holographic projection interfaces, blockchain-based identity and transaction platforms, AR workspaces and environments, voice-activated and conversational AI platforms, VR engagement spaces, quantum communication networks, digital olfaction and taste interfaces, neuro-interactive interfaces, AI-driven predictive modeling interfaces, smart environment integration, intent-recognition systems, predictive analytics interfaces, emotionally intelligent interfaces, autonomous agent interfaces, AR guidance systems, quantum-assisted forecasting interfaces, or another interface not expressly listed herein.

By leveraging secure communication protocols such as TLS, the communication layer may ensure that all data transmission (e.g., including compliance reports and permit signal refresh requests) are encrypted and authenticated, safeguarding the information from interception or tampering during transit. The emphasis on secure channels may be crucial for the real-time monitoring and management of access permissions, which rely on the continuous assessment of compliance status to determine the validity of data access. This architecture may facilitate a robust defense against potential cyber threats and may also support the dynamic nature of permission control within the DAC framework, allowing for immediate adjustments to access rights in response to compliance changes.

Additionally or alternatively, the communication layer may leverage other secure communication protocols, such as Hypertext Transfer Protocol Secure (HTTPS), secure sockets layer (SSL)/TLS, Secure Shell Protocol (SSH), internet protocol security (IPsec), datagram TLS (DTLS), Wi-Fi Protected Access 3 (WPA3), Secure/Multipurpose internet Mail Extensions (S/MIME), Open Pretty Good Privacy (OpenPGP), Signal Protocol, OAuth 2.0, Quick User Datagram Protocol (UDP) Internet Connections (QUIC), WireGuard, Kerberos, Secure Real-time Transport Protocol (SRTP), Lightweight Directory Access Protocol (LDAP) over SSL (LDAPS), Simple Network Management Protocol version 3 (SNMPv3), Secure Copy Protocol (SCP), Pretty Good Privacy (PGP), Internet Key Exchange version 2 (IKEv2), or another secure communication protocol not expressly listed herein.

Additionally or alternatively, the communication layer may implement and/or leverage other secure communication protocols, such as quantum encryption, post-quantum cryptography (PQC), AI-optimized encryption algorithms, intelligent threat detection and response, automated security policy management, secure (SMPC) protocols, quantum-resistant authentication, energy-efficient cryptography, dynamic biometric verification protocols, context-aware security protocols, decentralized identity and authentication protocols (DIAP), quantum-enhanced secure channel protocols (QESCP), AI-managed encryption protocols (AIMEP), homomorphic encryption protocols, zero-knowledge proof protocols, federated learning security protocols, SMPC enhanced protocols, intelligent anomaly detection systems (IADS), adaptive security protocols, predictive threat detection protocols, behavioral biometrics authentication, quantum-resilient cryptography, AI-driven encryption key management, self-healing networks, zero-knowledge proofs for privacy preservation, SMPC for collaborative security, context-aware access control, intelligent anomaly and intrusion detection systems (IDS), or another secure communication protocol.

In some aspects, the secure communication described herein may occur at a Layer 2 (e.g., data link layer) and/or a Layer 2.5 (e.g., considered as part of network protocols that do not fit neatly into traditional open systems interconnection (OSI) model layers, such as multiprotocol label switching (MPLS)) of the OSI model. Secure communications on the Layer 2 and/or Layer 2.5 of the OSI model may protect the content 202 and/or DAC as the content 202 and/or DAC traverse local networks or are transported across different segments of a network infrastructure. Protocols and mechanisms designed for these layers may provide security features such as encryption, integrity checks, and secure authentication directly on the network hardware or at the link level between devices. For example, these protocols and mechanisms may include a medium access control security (MACsec) protocol (e.g., defined in Institute of Electrical and Electronics Engineers (IEEE) standard 802.1AE), Link Layer Discovery Protocol-Media Endpoint Discovery (LLDP-MED), IEEE standard 802.1X, MPLS, secure virtual local area networks (VLANs), virtual private wire service (VPWS), virtual private local area network (LAN) service (VPLS), QKD for Layer 2 networks, Layer 2 tunnels with encryption, protected extensible authentication protocol (PEAP), or another protocol or mechanism not listed herein.

In some aspects, the communication layer may integrate homomorphic encryption (e.g., PHE, SHE, FHE, LHE, etc.) may further elevate security capabilities of the communication layer by enabling operations on encrypted data without the need for decryption. The application of homomorphic encryption at the communication layer may correspond to compliance checks and permit signal refresh processes that could be performed while the data remains encrypted, thus eliminating exposure risks associated with data decryption during transmission or processing. Homomorphic encryption may be particularly advantageous in scenarios where highly sensitive data is involved, as homomorphic encryption minimizes vulnerability of the content 202 at every stage of the communication process. Further, the use of homomorphic encryption may enhance the privacy-preserving aspects of the DAC, allowing for the secure exchange of information and access permissions without compromising the confidentiality of the underlying data. Additionally or alternatively, the communication layer may incorporate one or more other encryption algorithms as provided previously.

In the preceding description, the real-time communication described may include and/or implement real-time timing, near real-time timing, periodic timing, event-triggered timing, periodic timing, event-triggered timing, cyclical timing, batch processing timing, synchronous timing, asynchronous timing, time-bound timing, stream processing timing, latency-sensitive timing, time-sensitive networking, time division multiplexing, concurrency timing, scalability timing, reliability timing, security timing, data consistency timing, performance timing, interoperability timing, maintainability timing, cost timing, regulatory compliance timing, hybrid timing, or another timing not expressly listed herein.

Additionally or alternatively, access timing (e.g., in the context of data access and communication systems) may determine a responsiveness and efficiency of services and application. When discussing how the content owner and the content recipient (e.g., user) engage, one or more access timing factors may be considered. For example, the access timing factors may include batch processing, on-demand access, scheduled access, event-driven access, stream processing, asynchronous access, synchronous access, lazy loading, preemptive access, interactive access, or other factors not expressly listed herein.

In some aspects, every DAC that is generated may incorporate a digital identity (e.g., ID assigned by the content owner and/or an ID created by a DAC management system that corresponds to the content owner). The digital identify may be used to identify the agent or owner of the content that is protected inside the DAC, which may represent an improvement over traditional IAM systems. For example, this improvement may be primarily characterized by the integration of content governance directly with digital identity, enhancing content security, provenance, and compliance management in a unified manner. By embedding a digital identity within each DAC, a clear and immutable linkage may be formed between the digital content and its owner or responsible agent. This connection may ensure a higher level of content provenance and integrity, as every piece of content can be directly traced back to its source. Unlike traditional IAM (e.g., which focuses on securing access to systems and resources without necessarily linking content to its creator), the DAC approach may ensure that the origins, authenticity, and integrity of content are verifiable, providing a robust framework for managing digital rights and ownership.

Additionally or alternatively, the DAC model may integrate governance policies and digital identity within the same encapsulation, offering a unified approach to content management. This integration may allow for the enforcement of usage rules, access controls, and distribution policies directly linked to the content's identity, streamlining compliance and governance processes. In contrast, IAM systems typically manage user identities and access separately from content governance, requiring additional layers of integration to associate content with specific policies or owners. With each DAC having a digital identity tied to specific governance policies, the system may automatically enforce compliance with these policies across different platforms and use cases. This capability may represent a significant advancement over traditional IAM systems, where policy enforcement may require manual intervention or complex configuration.

Additionally, the DAC may ensure that content usage always adheres to the owner's terms, regardless of where or how the content is accessed, enhancing the scalability and effectiveness of digital asset management. In some aspects, incorporating digital identities into DACs may enable proactive security measures tailored to the content level, including advanced encryption, digital signatures, and potentially quantum-resistant algorithms. These measures may go beyond the scope of traditional IAM by protecting the content itself, not just the systems or platforms where the content resides. This content-centric security model may address the evolving threats in the digital landscape, offering a more comprehensive protection mechanism for digital assets.

Additionally, the DAC model may facilitate decentralized verification of content ownership and authenticity without relying on centralized authorities or systems. This approach may contrast with traditional IAM systems that often depend on centralized directories or authentication services. By enabling decentralized verification, the DAC may enhance privacy, reduce reliance on single points of failure, and support a more distributed and resilient digital ecosystem. In essence, the DAC's incorporation of digital identity directly with content governance and security may represent a forward-thinking improvement over traditional IAM solutions.

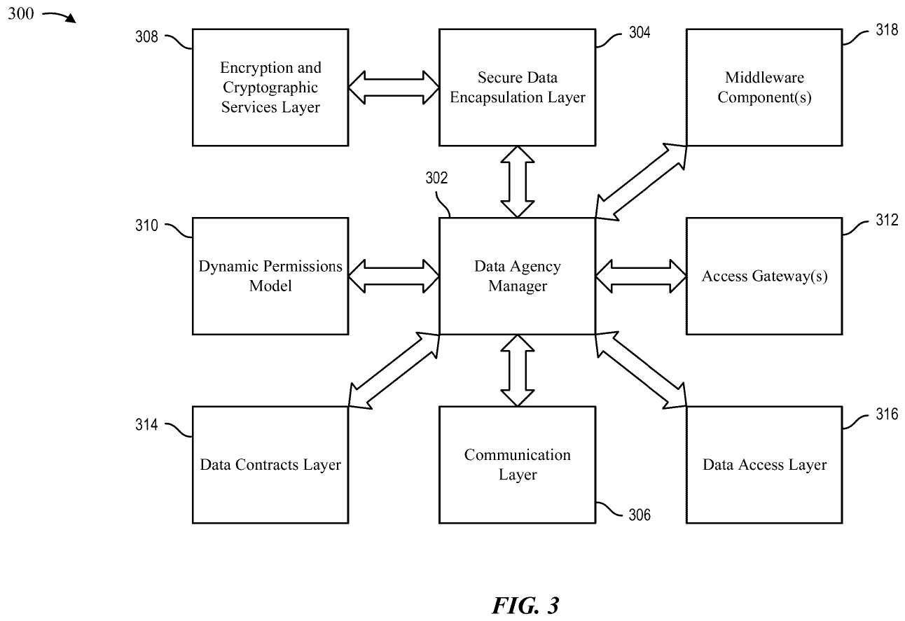

FIG. 3 depicts an example DAC architecture 300 for encapsulating content with defined governing logic for the content in accordance with aspects of the present disclosure. For example, the DAC architecture 300 may represent an architecture of a DAC as described herein for forming a DAC by binding content (e.g., the content 202 as described with reference to FIG. 2) with governing logic for the content (e.g., the governing logic 204 as described with reference to FIG. 2). In some aspects, the DAC architecture 300 may include a data agency manager 302, a secure data encapsulation layer 304, a communication layer 306, an encryption and cryptographic service layer 308, a dynamic permissions model 310, one or more access gateways 312, a data contracts layer 314, a data access layer 316, and one or more middleware components 318.

In some aspects, the data agency manager 302 may act as a central authority that oversees the establishment, enforcement, and verification of ownership rights for content (e.g., the content 202 as described with reference to FIG. 2), as well as the execution of the governance policies embedded within a DAC. A primary role of the data agency manager 302 may include facilitating seamless interaction between content owners or content agents and the users of the content, ensuring that all transactions adhere to the predefined terms and conditions set by the owners. Additionally, the data agency manager 302 may be in charge of other roles, such as centralized management of ownership rights, enforcement of governance policies, verification and audit, facilitation of dynamic permissions, interoperability and integration support, and/or other roles not expressly listed herein.

For the centralized management of ownership rights, the data agency manager 302 may provide a structured and centralized framework for managing the complexities associated with data ownership and agency, such as recording ownership claims, handling transfers of ownership, and maintaining a ledger of ownership history, thereby ensuring clarity and transparency around the ownership of data assets. For the enforcement of governance policies, the data agency manager 302 may act as an intermediary that interprets and enforces the governance policies encoded within the DACs, and the data agency manager 302 may ensure that all access and usage (e.g., of content within a DAC) comply with stipulations of the content owner. In some aspects, the data agency manager 302 may automate the enforcement process, reducing the likelihood of unauthorized access or misuse of data.

For the verification and audit, the data agency manager 302 may also play a crucial role in verifying the integrity and compliance of transactions involving DACs, and the data agency manager 302 may audit interactions to ensure that the interactions comply with the embedded governance policies, providing an additional layer of security and trust in the system. For the facilitation of dynamic permissions (e.g., given a reliance on the dynamic permissions model 310 for the DAC architecture as described with reference to FIG. 2), the data agency manager 302 may manage the issuance, renewal, and revocation of permit signals based on real-time compliance assessments, which may ensure that access to content is always contingent on adherence to the current terms and conditions (e.g., governing logic), enhancing the control data owners have over their assets. For the interoperability and integration support, the data agency manager 302 may also facilitate interoperability between different systems and platforms, ensuring that the DACs can be effectively used across a wide range of environments (e.g., the one or more external systems as described with reference to FIG. 2). By providing standard interfaces and protocols for data exchange, the data agency manager 302 may enhance the utility and applicability of the DACs.

In some aspects, the secure data encapsulation layer 304 may be a foundational layer of the DAC architecture 300 that integrates content with its governance policies (e.g., governing logic), including usage rules, lifecycle management instructions, and contractual terms, directly within a structure of the DAC. The secure data encapsulation layer 304 may employ advanced containerization technologies to create self-contained units where data and its governance logic are inseparable, enforcing compliance and control at the data level, as described in greater detail with reference to FIG. 2.

In some aspects, the encryption and cryptographic services layer 308 may safeguard the confidentiality and integrity of the content within each DAC. The encryption and cryptographic services layer 308 may utilize state-of-the-art cryptographic algorithms to encrypt the content and DAC (e.g., as described in greater detail with reference to FIG. 2), making the content and DAC tamper-proof and confidential. In some aspects, digital signatures may be employed to maintain the integrity of the content and its associated governance policies, facilitating secure and verifiable transactions.

In some aspects, the dynamic permissions model 310 may use cryptographic techniques (e.g., as described in greater detail with reference to FIG. 2) to generate and manage periodic refreshes of permit signals. Additionally, the dynamic permissions model 310 may use a secure handshake mechanism to validate compliance with the agreed-upon terms and conditions between a system of a user (e.g., a user requesting access to content and/or a DAC) and a system of the content owner or content agent. Additionally, the dynamic permissions model 310 may use an automatic revocation mechanism of the permit signal (e.g., leveraging cryptographic protocols, as described in greater detail with reference to FIG. 2) in case of non-compliance or breach of contract, which may ensure the content and/or DAC transitions into a deny state.

In some aspects, the communication layer 306 may use secure channels to facilitate the exchange of compliance reports and permit signal refresh requests. The communication layer 306 may ensure transmissions of the content and/or DAC are encrypted and authenticated by utilizing secure communication protocols (e.g., TLS and/or other secure communication protocols as described in greater detail with reference to FIG. 2). Additionally, the communication layer 306 may be responsible for the real-time (e.g., near real-time, periodic, on request, push-pull, etc.) monitoring and management of access permissions based on continuous compliance status assessment.

In some aspects, the data contracts layer 314 and the data access layer 316 may be separately encrypted layers that require distinct decryption and authorization for access. Additionally, the data contracts layer 314 and the data access layer 316 may be cryptographically tied using an ID of the content owner or content agent. For example, unique hashes generated from this linkage (e.g., cryptographically tied to each other) may create unique keys for each of the data contracts layer 314 and the data access layer 316, which may enhance security and ensure that contract terms are closely adhered to.

As described herein, the DAC architecture 300 may include the data agency manager 302. The data agency manager 302 may be configured to facilitate communication of content from a content owner to a user based on defined governance logic for the content. In some aspects, the content may be any type of content and/or digital content as described with reference to FIG. 2. For example, the content may include data and one or more functions for the data. Additionally or alternatively, the content may include textual content, visual content, audio content, software, source code, or another type of content. In some aspects, the defined governance logic may include usage rules, lifecycle management instructions, contractual terms, or a combination thereof. In some aspects, the corresponding defined governance logic for the content may be provided by the content owner.

As described herein, the DAC architecture 300 may also include the secure data encapsulation layer 304 (e.g., data encapsulation layer) coupled to the data agency manager 302. In some aspects, the data encapsulation layer 304 may be configured to bind the content to the defined governance logic, where the content bound to the defined governance logic may include a self-contained unit, as described herein. Additionally, the DAC architecture 300 may also include the communication layer 306 coupled to the data agency manager 302. In some aspects, the communication layer 306 may be configured to communicate one or more self-contained units from the content owner to the user according to the defined governance logic in each self-contained unit.

As described herein, the DAC architecture 300 may also include the encryption and cryptographic services layer 308 coupled to the secure data encapsulation layer 304. In some aspects, the encryption and cryptographic services layer 308 may be configured to perform, prior to binding the content to the defined governance logic, a first encryption process on the content and to perform, prior to binding the content to the defined governance logic, a second encryption process on the defined governance logic. For example, the first encryption process and the second encryption process may include partially homomorphic encryption algorithm, a homomorphic encryption algorithm, an FHE algorithm, an MPC algorithm, an AES algorithm, a triple DES algorithm, RSA, ECC, ChaCha20, Twofish, QKD, Post-Quantum Cryptography Algorithms, SHA-3, Blowfish, Camellia, CAST-128/CAST5, CAST-256/CAST6, Serpent, IDEA, Threefish, McEliece Cryptosystem, NewHope, or another encryption algorithm. In some aspects, the encryption and cryptographic services layer 308 may be further configured to switch between one or more of the encryption algorithms. Additionally, the encryption and cryptographic services layer 308 may further be configured to employ a cryptographic signature from the content owner for the defined governance logic for the content.

In some aspects, the data agency manager 302 may further be configured to authenticate the user based on a user identifier associated with the user and confirmation that the user has installed a data management system agent on a device of the user. For example, the user identifier is linked to access rights for the data user.

As described herein, the DAC architecture 300 may include the dynamic permissions model 310 coupled to the data agency manager 302. In some aspects, the dynamic permissions model 310 may be configured to monitor interactions between the user and the one or more self-contained units communicated via the communication layer 306, where the interactions are monitored with respect to the defined governance logic in each self-contained unit of the one or more self-contained units. For example, the dynamic permissions model 310 may monitor the interactions in real-time (e.g., near real-time, periodic, on request, push-pull, etc.). Additionally, the dynamic permissions model 310 may be further configured to receive one or more compliance reports from the user via one or more interfaces, access points, or both configured on a device of the user.

In some aspects, the dynamic permissions model 310 may be further configured to send, to a device of the user, a periodic permit signal. Subsequently, the dynamic permissions model 310 may be configured to receive, from the device of the user, a response to each instance of the periodic permit signal, where the response indicates whether the user is accessing the one or more self-contained units according to the corresponding defined governance logic in each self-contained unit. In some aspects, the data agency manager 302 may be configured to determine whether the monitored interactions comply with the corresponding governance logic in each self-contained unit of the one or more self-contained units. Additionally, the data agency manager 302 may be configured to revoke access to the one or more self-contained units for the user based on determining the monitored instances do not comply with the defined governance logic in each self-contained unit.

As described herein, the DAC architecture 300 may include the one or more access gateways 312 coupled to the data agency manager 302. In some aspects, the one or more access gateways 312 may be configured to integrate the one or more self-contained units with one or more external systems for communicating the one or more self-contained units to the user. For example, the one or more external systems may include an API system, a PubSub system, an RSS system, RESTful APIs, GraphQL, WebSocket, SSE, SOAP, MQTT, AMQP, gRPC, RSS/Atom Feeds, Webhooks, Odata, CoAP, JSON-RPC, XML-RPC, STOMP, SignalR, Apache Kafka, RSocket, ZeroMQ or another external system.

As described herein, the DAC architecture 300 may include the data contracts layer 314 coupled to the data agency manager 302. In some aspects, the data contracts layer 314 may be configured to generate and manage unique cryptographic keys for each self-contained unit of the one or more self-contained units. Additionally, the data contracts layer 314 may be further configured to change the unique cryptographic keys.

In some aspects, the communication layer 306 may be configured to communicate, via a communication protocol, the defined governance logic for each self-contained unit of the one or more self-contained units to the data user. For example, the communication protocol may include a secure communication protocol described with reference to FIG. 2. In some aspects, the data agency manager 302 may be configured to authorize access to the one or more self-contained units for the user based on a compliance of the user according to the defined governance logic in each self-contained unit of the one or more self-contained units.

In some aspects, the data agency manager 302 may be configured to manage one or more versions of at least a first self-contained unit of the one or more self-contained units, where the one or more versions comprise updated content for the first self-contained unit and may apply the defined governance logic in the first self-contained unit to the one or more versions. Additionally or alternatively, the one or more versions may include updated content for the first self-contained unit and/or updated governance logic for the first self-contained unit, and the data agency manager 302 may be configured to apply the updated defined governance logic to the one or more versions of the first self-contained unit.

In some aspects, the data agency manager 302 may be configured to store the one or more self-contained units via a secure storage system. Additionally, the data agency manager 302 may be configured to dynamically scale the secure storage system to store additional self-contained units.

In some aspects, the communication layer 306 may be configured to communicate the one or more self-contained units from the content owner to the user based on a secure communication protocol. For example, the secure communication protocol may include HTTPS, SSL/TLS, SSH, IPsec, DTLS, WPA3, S/MIME, OpenPGP, Signal Protocol, OAuth 2.0, QUIC, WireGuard, Kerberos, SRTP, LDAPS, SNMPv3, SCP, PGP, IKEv2, or another secure communication protocol.

In some aspects, the data agency manager 302 may be configured to receive, from a device of the user, a request to generate derivative content of an indicated self-contained unit of the one or more self-contained units, where the derivative content comprises modified content in the indicated self-contained unit. Subsequently, the data agency manager 302 may be configured to generate a derivative self-contained unit comprising the derivative content based on whether the defined governance logic for the indicated self-contained unit allows for derivative content generation, where the derivative self-contained unit includes the defined governance logic in the indicated self-contained unit.

As described herein, the DAC architecture 300 may include the data access layer coupled to the data agency manager, the data access layer 316 configured to employ an end-to-end encryption for communicating, via the communication layer 306, the one or more self-contained units. For example, the end-to-end encryption may include using unique cryptographic keys for encrypting the one or more self-contained units, where the unique cryptographic keys are linked to the content owner, the user, the content in the one or more self-contained units, or a combination thereof. Additionally, the data access layer 316 may be configured and/or allowed to change the unique cryptographic keys.

In some aspects, the DAC architecture 300 may include and/or utilize a first user interface (not pictured) on a device of the content owner configured to enable the content owner to manage one or more parameters of the one or more self-contained units. Additionally, the DAC architecture 300 may include and/or utilize a second user interface on a device of the user configured to enable the user to access the one or more self-contained units.

In some aspects, the data agency manager 302 may be configured to dynamically scale a number of concurrent user sessions for a plurality of users to access corresponding self-contained units. In some aspects, the content in a corresponding self-contained unit may include anonymous content.

In some aspects, the data agency manager 302 may be configured to store historical information for the one or more self-contained units. For example, the historical information may include ownership history for each self-contained unit of the one or more self-contained units, access information for each self-contained unit, modification information for each self-contained unit, sharing information for each self-contained unit, or a combination thereof.

In some aspects, the data agency manager 302 may be configured to perform a recovery mechanism based on whether a loss of content or a system failure is detected. Accordingly, the recovery mechanism may recover the one or more self-contained units prior to the loss of content or system failure. In some aspects, the data agency manager 302 may be configured to backup the one or more self-contained units in a secure storage system, and the recovery mechanism may recover the one or more self-contained units based on the backup.

In some aspects, the data agency manager 302 may be configured to transfer ownership of the one or more self-contained units to an additional content owner.

As described herein, the DAC architecture 300 may include the one or more middleware components 318 coupled to the data agency manager 302. In some aspects, the one or more middleware components 318 may be configured to facilitate processing of content, analysis of content, or both for the one or more self-contained units.

In some aspects, the data agency manager 302 may be configured to enforce retention schedules and deletion schedules for the one or more self-contained units based on the defined governance logic for each self-contained unit of the one or more self-contained units. For example, the retention schedules may include amounts of time that the user is allowed to access the one or more self-contained units. Additionally, the deletion schedules may include ending times that revoke access to the one or more self-contained units for the user upon reaching the ending times.

In some aspects, the data agency manager 302 may be configured to generate real-time (e.g., near real-time, periodic, on request, push-pull, etc.) alerts, based on the defined governance logic in each self-contained unit of the one or more self-contained units, for potential compliance breaches of the one or more self-contained units, unauthorized access attempts of content in the one or more self-contained units, unauthorized modification attempts of content in the one or more self-contained units, or a combination thereof. In some aspects, the communication layer 306 may be configured to send the real-time alerts to a device of the user.

In some aspects, the secure data encapsulation layer 304 may be configured to apply updated defined governance logic to the one or more self-contained units. Subsequently, the communication layer 306 may be configured to send an indication of the updated defined governance logic to a device of the user.

In some aspects, the data agency manager 302 may be configured to implement a role-based access control (RBAC) system for managing different levels of access to the one or more self-contained units for the user based on defined user roles.

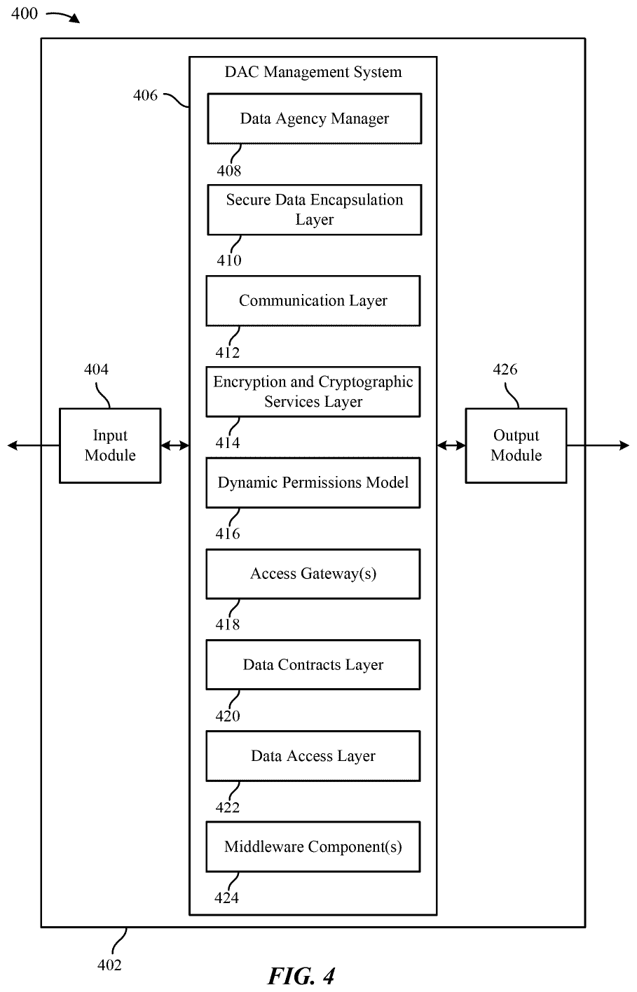

FIG. 4 depicts a block diagram 400 of an apparatus 402 that supports encapsulating content with defined governing logic for the content in accordance with aspects of the present disclosure. The apparatus 402 may include an input module 404, a DAC management system 406, and an output module 426. The apparatus 402 may also include a processor. Each of these components may be in communication with one another and/or coupled with one another (e.g., via one or more buses). In some cases, the apparatus 402 may be an example of a user terminal, a database server, or a system containing multiple computing devices.

The input module 404 may manage input signals for the apparatus 402. For example, the input module 404 may identify input signals based on an interaction with a modem, a keyboard, a mouse, a touchscreen, or a similar device. These input signals may be associated with user input or processing at other components or devices. In some cases, the input module 404 may utilize an operating system such as iOS®, ANDROID®, MS-DOS®, MS-WINDOWS®, OS/2®, UNIX®, LINUX®, or another known operating system to handle input signals.

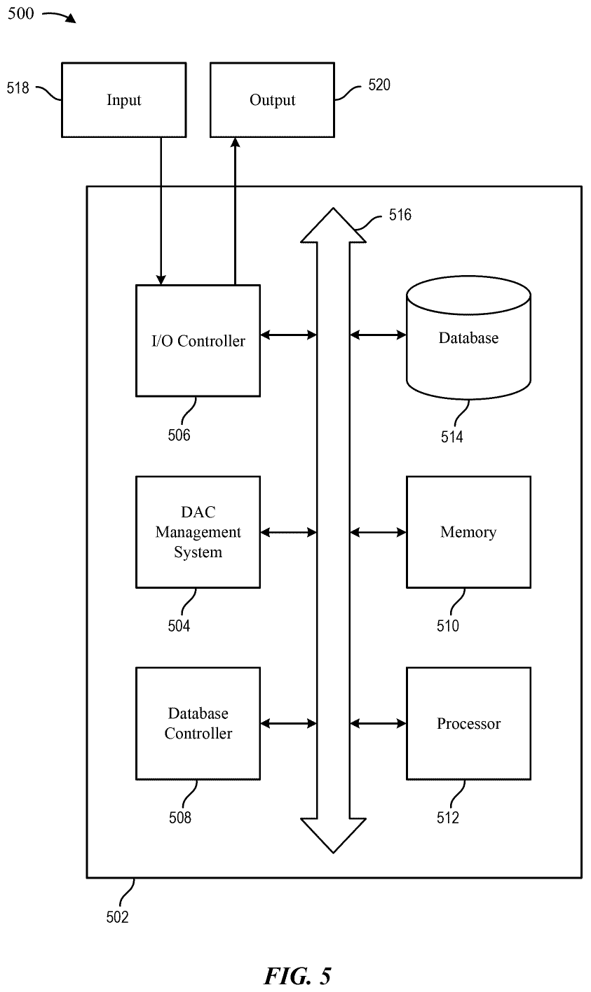

The input module 404 may send aspects of these input signals to other components of the apparatus 402 for processing. For example, the input module 404 may transmit input signals to the DAC management system 406 to support encapsulating content with defined governing logic for the content. In some cases, the input module 404 may be a component of an input/output (I/O) controller 506 as described with reference to FIG. 5.

The DAC management system 406 may include a data agency manager 408, a secure data encapsulation layer 410, a communication layer 412, an encryption and cryptographic service layer 414, a dynamic permissions model 416, one or more access gateways 418, a data contracts layer 420, a data access layer 422, and one or more middleware components 424. The DAC management system 406 may be an example of aspects of a DAC management system 504 as described with reference to FIG. 5. In some examples, the DAC management system 406 may include and/or use the DAC architecture 300 as described with reference to FIG. 3, such that each of the components of the DAC management system 406 may correspond to the similarly named components of the DAC architecture 300. Accordingly, each of the components of the DAC management system 406 may be configured to operate and coupled to other components as described with reference to the components of the DAC architecture 300.

The DAC management system 406 and/or at least some of its various sub-components may be implemented in hardware, software executed by a processor, firmware, or any combination thereof. If implemented in software executed by a processor, the functions of the DAC management system 406 and/or at least some of its various sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure. The DAC management system 406 and/or at least some of its various sub-components may be physically located at various positions, including being distributed such that portions of functions are implemented at different physical locations by one or more physical devices.

In some examples, the DAC management system 406 and/or at least some of its various sub-components may be a separate and distinct component in accordance with various aspects of the present disclosure. In other examples, the DAC management system 406 and/or at least some of its various sub-components may be combined with one or more other hardware components, including but not limited to an IO component, a transceiver, a network server, another computing device, one or more other components described in the present disclosure, or a combination thereof in accordance with various aspects of the present disclosure.

The output module 426 may manage output signals for the apparatus 402. For example, the output module 426 may receive signals from other components of the apparatus 402, such as the DAC management system 406, and may transmit these signals to other components or devices. In some specific examples, the output module 426 may transmit output signals for display in a user interface, for storage in a database or data store, for further processing at a server or server cluster, or for any other processes at any number of devices or systems. In some cases, the output module 426 may be a component of an I/O controller 506 as described with reference to FIG. 5.

FIG. 5 shows a diagram of a system 500 including a device 502 that supports encapsulating content with defined governing logic for the content in accordance with aspects of the present disclosure. The device 502 may be an example of or include the components of a source database or an apparatus 402 as described herein. The device 502 may include components for bi-directional data communications including components for transmitting and receiving communications, including a DAC management system 504, an I/O controller 506, a database controller 508, memory 510, a processor 512, and a database 514. These components may be in electronic communication via one or more buses (e.g., bus 516).

The DAC management system 504 may be an example of a DAC management system 406 and/or employ the DAC architecture 300 as described herein. For example, the DAC management system 504 may implement and/or perform any of the methods, systems, or processes described above with reference to FIGS. 3 and 4. In some cases, the DAC management system 504 may be implemented in hardware, software executed by a processor, firmware, or any combination thereof.

The I/O controller 506 may manage inputs signals 518 and output signals $20 for the device 502. The I/O controller 506 may also manage peripherals not integrated into the device 502. In some cases, the I/O controller 506 may represent a physical connection or port to an external peripheral. In some cases, the I/O controller 506 may utilize an operating system such as iOS®, ANDROID®, MS-DOS®, MS-WINDOWS®, OS/2, UNIX®, LINUX®, or another known operating system. In other cases, the I/O controller 506 may represent or interact with a modem, a keyboard, a mouse, a touchscreen, or a similar device. In some cases, the I/O controller 506 may be implemented as part of a processor. In some cases, a user may interact with the device 502 via the I/O controller 506 or via hardware components controlled by the I/O controller 506.

The database controller 508 may manage data storage and processing in a database 514. In some cases, a user may interact with the database controller 508. In other cases, the database controller 508 may operate automatically without user interaction. The database 514 may be an example of a single database, a distributed database, multiple distributed databases, a data store, a data lake, or an emergency backup database.

Memory 510 may include RAM and read-only memory (ROM). The memory 510 may store computer-readable, computer-executable software including instructions that, when executed, cause the processor to perform various functions described herein. In some cases, the memory 510 may contain, among other things, a basic input/output system (BIOS) which may control basic hardware or software operation such as the interaction with peripheral components or devices.

The processor 512 may include an intelligent hardware device (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 512 may be configured to operate a memory array using a memory controller. In other cases, a memory controller may be integrated into the processor 512. The processor 512 may be configured to execute computer-readable instructions stored in a memory 510 to perform various functions (e.g., functions or tasks supporting encapsulating content with defined governing logic for the content).

In some embodiments, a system for content encapsulation and secure communication of content includes: a data agency manager configured to facilitate communication of content from a content owner to a user based at least in part on defined governance logic for the content; a data encapsulation layer coupled to the data agency manager, the data encapsulation layer configured to bind the content to the defined governance logic, wherein the content bound to the defined governance logic comprises a self-contained unit; and a communication layer coupled to the data agency manager, the communication layer configured to communicate one or more self-contained units from the content owner to the user according to the defined governance logic in each self-contained unit.

In some embodiments, the systems also includes an encryption and cryptographic services layer coupled to the data encapsulation layer, the encryption and cryptographic services layer configured to: perform, prior to binding the content to the defined governance logic, a first encryption process on the content; and perform, prior to binding the content to the defined governance logic, a second encryption process on the defined governance logic. In some embodiments, the first encryption process and the second encryption process comprises a fully homomorphic encryption (FHE) algorithm or another encryption algorithm. In some embodiments, the encryption and cryptographic services layer is further configured to switch between one or more encryption algorithms. In some embodiments, the encryption and cryptographic services layer is further configured to employ a cryptographic signature from the content owner for the defined governance logic for the content. In some embodiments, the data agency manager is further configured to authenticate the user based on a user identifier associated with the user and confirmation that the user has installed a data management system agent on a device of the user. In some embodiments, the user identifier is linked to access rights for the user. In some embodiments, the system also includes a dynamic permissions model coupled to the data agency manager, the dynamic permissions model configured to monitor interactions between the user and the one or more self-contained units communicated via the communication layer, wherein the interactions are monitored with respect to the defined governance logic in each self-contained unit of the one or more self-contained units. In some embodiments, the interactions are monitored in real-time. In some embodiments, the dynamic permissions model is further configured to receive one or more compliance reports from the user via one or more interfaces, access points, or both configured on a device of the user. In some embodiments, the dynamic permissions model is further configured to: send, to a device of the user, a periodic permit signal; and receive, from the device of the user, a response to each instance of the periodic permit signal, wherein the response indicates whether the user is accessing the one or more self-contained units according to the defined governance logic in each self-contained unit. In some embodiments, the data agency manager is further configured to: determine whether the monitored interactions comply with the defined governance logic in each self-contained unit of the one or more self-contained units; and revoke access to the one or more self-contained units for the user based at least in part on determining the monitored instances do not comply with the defined governance logic in each self-contained unit. In some embodiments, the system also includes one or more access gateways coupled to the data agency manager, the one or more access gateways configured to integrate the one or more self-contained units with one or more external systems for communicating the one or more self-contained units to the user. In some embodiments, the one or more external systems comprise an application programming interface (API) system or another external system. In some embodiments, the defined governance logic for the content is provided by the content owner. In some embodiments, the system also includes a data contracts layer coupled to the data agency manager, the data contracts layer configured to generate and manage unique cryptographic keys for each self-contained unit of the one or more self-contained units. In some embodiments, the data contracts layer is further configured to change the unique cryptographic keys. In some embodiments, the communication layer is further configured to communicate, via a communication protocol, the defined governance logic in each self-contained unit of the one or more self-contained units to the user. In some embodiments, the data agency manager is further configured to authorize access to the one or more self-contained units for the user based at least in part on a compliance of the user according to the defined governance logic in each self-contained unit of the one or more self-contained units. In some embodiments, the data agency manager is further configured to: manage one or more versions of at least a first self-contained unit of the one or more self-contained units, wherein the one or more versions comprise updated content for the first self-contained unit; and apply the defined governance logic in the first self-contained unit to the one or more versions. In some embodiments, the data agency manager is further configured to: manage one or more versions of at least a first self-contained unit of the one or more self-contained units, wherein the one or more versions comprise updated content for the first self-contained unit, updated governance logic for the first self-contained unit, or a combination thereof; and apply the updated defined governance logic to the one or more versions of the first self-contained unit. In some embodiments, the data agency manager is further configured to store the one or more self-contained units via a secure storage system. In some embodiments, the data agency manager is further configured to dynamically scale the secure storage system to store additional self-contained units. In some embodiments, the communication layer is further configured to communicate the one or more self-contained units from the content owner to the user based at least in part on a secure communication protocol. In some embodiments, the secure communication protocol comprises a transport layer security (TLS) protocol or another secure communication protocol. In some embodiments, the data agency manager is further configured to: receive, from a device of the user, a request to generate derivative content of an indicated self-contained unit of the one or more self-contained units, wherein the derivative content comprises modified content in the indicated self-contained unit; and generate a derivative self-contained unit comprising the derivative content based at least in part on whether the defined governance logic for the indicated self-contained unit allows for derivative content generation, wherein the derivative self-contained unit comprises the defined governance logic in the indicated self-contained unit. In some embodiments, the system includes a data access layer coupled to the data agency manager, the data access layer configured to employ an end-to-end encryption for communicating, via the communication layer, the one or more self-contained units. In some embodiments, the end-to-end encryption comprises using unique cryptographic keys for encrypting the one or more self-contained units, and wherein the unique cryptographic keys are linked to the content owner, the user, the content in the one or more self-contained units, or a combination thereof. In some embodiments, the data access layer is further configured to change the unique cryptographic keys. In some embodiments, the system includes: a first user interface on a device of the content owner configured to enable the content owner to manage one or more parameters of the one or more self-contained units; and a second user interface on a device of the user configured to enable the user to access the one or more self-contained units. In some embodiments, the data agency manager is further configured to dynamically scale a number of concurrent user sessions for a plurality of users to access corresponding self-contained units. In some embodiments, the content in a corresponding self-contained unit comprises anonymous content. In some embodiments, the data agency manager is further configured to store historical information for the one or more self-contained units, wherein the historical information comprises ownership history for each self-contained unit of the one or more self-contained units, access information for each self-contained unit, modification information for each self-contained unit, sharing information for each self-contained unit, or a combination thereof. In some embodiments, the data agency manager is further configured to perform a recovery mechanism based at least in part on whether a loss of content or a system failure is detected, wherein the recovery mechanism recovers the one or more self-contained units prior to the loss of content or system failure. In some embodiments, the data agency manager is further configured to backup the one or more self-contained units in a secure storage system, wherein the recovery mechanism recovers the one or more self-contained units based at least in part on the backup. In some embodiments, the data agency manager is further configured to transfer ownership of the one or more self-contained units to an additional content owner. In some embodiments, the system also includes one or more middleware components coupled to the data agency manager, the one or more middleware components configured to facilitate processing of content, analysis of content, or both for the one or more self-contained units. In some embodiments, the data agency manager is further configured to enforce retention schedules and deletion schedules for the one or more self-contained units based at least in part on the defined governance logic for each self-contained unit of the one or more self-contained units, wherein the retention schedules comprise amounts of time that the user is allowed to access the one or more self-contained units and the deletion schedules comprise ending times that revoke access to the one or more self-contained units for the user upon reaching the ending times. In some embodiments, data agency manager is further configured to generate real-time alerts, based at least in part on the defined governance logic in each self-contained unit of the one or more self-contained units, for potential compliance breaches of the one or more self-contained units, unauthorized access attempts of content in the one or more self-contained units, unauthorized modification attempts of content in the one or more self-contained units, or a combination thereof. In some embodiments, the communication layer is further configured to send the real-time alerts to a device of the user. In some embodiments, the data encapsulation layer is further configured to apply updated defined governance logic to the one or more self-contained units. In some embodiments, the communication layer is further configured to send an indication of the updated defined governance logic to a device of the user. In some embodiments, the data agency manager is further configured to implement a role-based access control (RBAC) system for managing different levels of access to the one or more self-contained units for the user based on defined user roles. In some embodiments, the defined governance logic for each self-contained unit of the one or more self-contained units comprises usage rules, lifecycle management instructions, contractual terms, or a combination thereof. In some embodiments, the content of each self-contained unit of the one or more self-contained units comprises data and one or more functions for the data. In some embodiments, the content of each self-contained unit of the one or more self-contained units comprises textual content, visual content, audio content, software, source code, or another type of content.

In some embodiments, a system for content encapsulation and secure communication of content includes: a data agency manager configured to facilitate communication of content from a content owner computing device to a user computing device based at least in part on defined governance logic for the content; a data encapsulation layer in communication with the data agency manager, the data encapsulation layer configured to bind the content to the defined governance logic, wherein the content bound to the defined governance logic is associated with a digital agency capsule; and a communication layer in communication with the data agency manager, the communication layer configured to communicate one or more a digital agency capsules from the content owner computing device to the user computing device according to the defined governance logic in each a digital agency capsule.

In some embodiments, the system also includes an encryption and cryptographic services layer in communication with the data encapsulation layer, the encryption and cryptographic services layer configured to: perform, prior to binding the content to the defined governance logic, a first encryption process on the content; and perform, prior to binding the content to the defined governance logic, a second encryption process on the defined governance logic. In some embodiments, the first encryption process and the second encryption process comprises a fully homomorphic encryption (FHE) algorithm or another encryption algorithm. In some embodiments, the encryption and cryptographic services layer is further configured to switch between one or more encryption algorithms. In some embodiments, the encryption and cryptographic services layer is further configured to employ a cryptographic signature from the content owner computing device for the defined governance logic for the content. In some embodiments, the data agency manager is further configured to authenticate a user of the user computing device based on a user identifier associated with the user and confirmation that the user has installed a data management system agent on the user computing device. In some embodiments, the user identifier is linked to access rights for the user. In some embodiments, the system includes a dynamic permissions model in communication with the data agency manager, the dynamic permissions model configured to monitor interactions between the user computing device and the one or more a digital agency capsules communicated via the communication layer, wherein the interactions are monitored with respect to the defined governance logic in each a digital agency capsule of the one or more a digital agency capsules. In some embodiments, the interactions are monitored in real-time. In some embodiments, the dynamic permissions model is further configured to receive one or more compliance reports from the user via one or more interfaces or access points of the user computing device. In some embodiments, the dynamic permissions model is further configured to: send, to the user computing device, a periodic permit signal; and receive, from the user computing device, a response to each instance of the periodic permit signal, wherein the response indicates whether the user is accessing the one or more a digital agency capsules according to the defined governance logic in each a digital agency capsule. In some embodiments, the data agency manager is further configured to: determine whether the monitored interactions comply with the defined governance logic in each a digital agency capsule of the one or more a digital agency capsules; and revoke access to the one or more a digital agency capsules for the user computing device based at least in part on determining the monitored instances do not comply with the defined governance logic in each a digital agency capsule. In some embodiments, the system also includes one or more access gateways coupled to the data agency manager, the one or more access gateways configured to integrate the one or more a digital agency capsules with one or more external systems for communicating the one or more a digital agency capsules to the user computing device. In some embodiments, the one or more external systems comprise an application programming interface (API) system or another external system.

In some embodiments, a method for content encapsulation and secure communication of content includes: facilitating communication of content from a content owner computing device to a user computing device based at least in part on defined governance logic for the content; binding the content to the defined governance logic, wherein the content bound to the defined governance logic is associated with a digital agency capsule; and communicating one or more a digital agency capsules from the content owner computing device to the user computing device according to the defined governance logic in each a digital agency capsule.

In some embodiments, the method also includes: performing, prior to binding the content to the defined governance logic, a first encryption process on the content; and performing, prior to binding the content to the defined governance logic, a second encryption process on the defined governance logic. In some embodiments, the first encryption process and the second encryption process comprises a fully homomorphic encryption (FHE) algorithm or another encryption algorithm. In some embodiments, the method also includes switching between one or more encryption algorithms. In some embodiments, the method also includes employing a cryptographic signature from the content owner computing device for the defined governance logic for the content.

In some embodiments, an computing device configured to encapsulate content and secure communication of content includes: a processor; and a memory including instructions that, when executed by the processor, cause the processor to: facilitate communication of content from a content owner computing device to a user computing device based at least in part on defined governance logic for the content; bind the content to the defined governance logic, wherein the content bound to the defined governance logic is associated with a digital agency capsule; and communicate one or more a digital agency capsules from the content owner computing device to the user computing device according to the defined governance logic in each a digital agency capsule.

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined.

Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.”

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. A system for content encapsulation and secure communication of content, the system comprising:
a data agency manager configured to facilitate communication of content from a content owner computing device to a user computing device based at least in part on defined governance logic for the content;
a data encapsulation layer in communication with the data agency manager, the data encapsulation layer configured to bind the content to the defined governance logic, wherein the content bound to the defined governance logic is associated with a digital agency capsule; and
a communication layer in communication with the data agency manager, the communication layer configured to communicate one or more a digital agency capsules from the content owner computing device to the user computing device according to the defined governance logic in each a digital agency capsule.

2. The system of claim 1, further comprising an encryption and cryptographic services layer in communication with the data encapsulation layer, the encryption and cryptographic services layer configured to:
perform, prior to binding the content to the defined governance logic, a first encryption process on the content; and
perform, prior to binding the content to the defined governance logic, a second encryption process on the defined governance logic.

3. The system of claim 2, wherein the first encryption process and the second encryption process comprises a fully homomorphic encryption (FHE) algorithm or another encryption algorithm.

4. The system of claim 3, wherein the encryption and cryptographic services layer is further configured to switch between one or more encryption algorithms.

5. The system of claim 2, wherein the encryption and cryptographic services layer is further configured to employ a cryptographic signature from the content owner computing device for the defined governance logic for the content.

6. The system of claim 1, wherein the data agency manager is further configured to authenticate a user of the user computing device based on a user identifier associated with the user and confirmation that the user has installed a data management system agent on the user computing device.

7. The system of claim 6, wherein the user identifier is linked to access rights for the user.

8. The system of claim 1, further comprising a dynamic permissions model in communication with the data agency manager, the dynamic permissions model configured to monitor interactions between the user computing device and the one or more a digital agency capsules communicated via the communication layer, wherein the interactions are monitored with respect to the defined governance logic in each a digital agency capsule of the one or more a digital agency capsules.

9. The system of claim 8, wherein the interactions are monitored in real-time.

10. The system of claim 8, wherein the dynamic permissions model is further configured to receive one or more compliance reports from the user via one or more interfaces or access points of the user computing device.

11. The system of claim 8, wherein the dynamic permissions model is further configured to:
send, to the user computing device, a periodic permit signal; and
receive, from the user computing device, a response to each instance of the periodic permit signal, wherein the response indicates whether the user is accessing the one or more a digital agency capsules according to the defined governance logic in each a digital agency capsule.

12. The system of claim 8, wherein the data agency manager is further configured to:
determine whether the monitored interactions comply with the defined governance logic in each a digital agency capsule of the one or more a digital agency capsules; and
revoke access to the one or more a digital agency capsules for the user computing device based at least in part on determining the monitored instances do not comply with the defined governance logic in each a digital agency capsule.

13. The system of claim 1, further comprising one or more access gateways coupled to the data agency manager, the one or more access gateways configured to integrate the one or more a digital agency capsules with one or more external systems for communicating the one or more a digital agency capsules to the user computing device.

14. The system of claim 13, wherein the one or more external systems comprise an application programming interface (API) system or another external system.

15. A method for content encapsulation and secure communication of content, the method comprising:
facilitating communication of content from a content owner computing device to a user computing device based at least in part on defined governance logic for the content;
binding the content to the defined governance logic, wherein the content bound to the defined governance logic is associated with a digital agency capsule; and
communicating one or more a digital agency capsules from the content owner computing device to the user computing device according to the defined governance logic in each a digital agency capsule.

16. The method of claim 15, further comprising:
performing, prior to binding the content to the defined governance logic, a first encryption process on the content; and
performing, prior to binding the content to the defined governance logic, a second encryption process on the defined governance logic.

17. The method of claim 16, wherein the first encryption process and the second encryption process comprises a fully homomorphic encryption (FHE) algorithm or another encryption algorithm.

18. The method of claim 17, further comprising switching between one or more encryption algorithms.

19. The method of claim 18, further comprising employing a cryptographic signature from the content owner computing device for the defined governance logic for the content.

20. An computing device configured to encapsulate content and secure communication of content, the computing device comprising:
a processor; and
a memory including instructions that, when executed by the processor, cause the processor to:
facilitate communication of content from a content owner computing device to a user computing device based at least in part on defined governance logic for the content;
bind the content to the defined governance logic, wherein the content bound to the defined governance logic is associated with a digital agency capsule; and
communicate one or more a digital agency capsules from the content owner computing device to the user computing device according to the defined governance logic in each a digital agency capsule.
